(19) United States
(12) Patent Application Publication
(10) Pub. No.: US 2015/0244946 A1
(43) Pub. Date: Aug. 27, 2015

(54) METHOD AND SYSTEMS FOR THERMAL IMAGE / VIDEO MEASUREMENTS AND PROCESSING

(71) Applicants: Sos Agaian, San Antonio, TX (US); Mehdi Roopaei, San Antonio, TX (US)

(72) Inventors: Sos Agaian, San Antonio, TX (US); Mehdi Roopaei, San Antonio, TX (US)

(21) Appl. No.: 14/533,061

(22) Filed: Nov. 4, 2014

Related U.S. Application Data
(60) Provisional application No. 61/899,864, filed on Nov. 4, 2013.

(51) Int. Cl. H04N 5/33

(52) U.S. Cl. CPC H04N 5/33

(57) ABSTRACT

The current invention relates to processing and analysis of image and video content. In an embodiment, the present invention offers a method, systems, and device to measure the quality of images and videos by combining several image quality components, including but not limited to brightness, darkness, density, and intensity, and more particularly to measuring the quality of thermal images or to evaluate image and video's brightness-darkness value. In another embodiment, the present invention offers a method for determining the percentage of enhancement in thermal, infrared, color, and gray scale images. In another embodiment, presented are methods and systems for a multi-threshold system for segmentation and color or gray scale and thermal image enhancement. In yet another embodiment, systems and methods for measuring the brightness and darkness in color images without losing the information by transforming the color space to a gray scale image is presented.

### CROSS-REFERENCE TO RELATED APPLICATIONS

This application claims the benefit under Title 35 United States Code §119(e) of U.S. Provisional Patent Application Ser. No. 61/899,864; Filed: Nov. 4, 2013, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods of use directed to image/video processing and analysis. More specifically, the present invention generally relates to systems and methods of use directed to reference/non-reference measurements of the quality of the thermal images and videos, image video enhancement, image segmentation, image multilevel threshold systems, image fusion measurements, gray scale image brightness-darkness measurements, color image brightness-darkness measurements, and image/video applications.

### BACKGROUND OF THE INVENTION

Without limiting the scope of the disclosed systems and methods, the background is described in connection with a novel system and approach to thermal imaging and video processing and measurement.

An image defined is considered to be a light intensity function of several real variables. For example, the value of the function I at any point (x,y) depends on the brightness and gray level (in black and white images) or RGB value (in colored image) at that point. Current digital technology has made it possible to process multi-dimensional signals. Currently, encountered are digital images and videos which are essentially discrete, so this means that the function I(x,y) has been made discrete both in terms of the coordinates and the value of I at any point. There are various applications of image processing application which include face detection, moving object tracking, automatic visual inspection systems, defense surveillance, intelligent transportation systems, remote sensing, measurements for the food industry, feature detection, medical image processing, computer vision (extraction of information from an image by a computer), and microscope image processing, etc. The goal of this process can be divided into several classes, including image/video processing (enhancement, color correction, segmentation, sharpening, warping, etc.) and image/video analysis (image measurements and standardization).

Recently, image-processing approaches based on the features of thermal images have been developed. Wide use of thermal imaging cameras has led to a growing interest in the application of infrared imaging techniques for the detection and identification of structures both in engineering and in living systems. Thermal imaging is a non-contact sensing method concerned with the measurement of electromagnetic radiation in the infrared region of the spectrum. The surface temperature distribution can be recovered after post-processing the sensor information and appropriate calibration. Since the surface temperature distribution depends on the properties of subsurface structures and regions, infrared imaging can be used to detect and identify subsurface structures by analyzing the differences in the thermal response of an undisturbed region. Thermal imaging is based on the following principle: when a surface is heated or cooled, variations in the thermal properties of a structure located underneath the surface result in identifiable temperature contours on the surface itself, differing from those present in the steady-state situation during passive imaging as well as from the surrounding regions. These contours are characteristic of the thermal properties of the base structure and subsurface perturbations, and can, when combined with a suitable model, provide information regarding the shape and depth of the perturbation. Therefore, observation and recognition of objects in thermal images because of object inherent infrared and thermal characteristic and detector disfigurement are difficult. As a result, infrared and thermal images are a kind of low contrast and noisy image, which should be enhanced. As a result, introducing metrics to determine the level of enhancement for thermal imaging is very important.

Thermal imaging has been used to (Infrared thermal imaging in medicine, E F J Ring and K Ammer 2012 Physiol. Meas. 33 R33 Doi:10.1088/0967-3334/33/3/R33) study a number of diseases where skin temperature can reflect the presence of inflammation in underlying tissues, or where blood flow is increased or decreased due to a clinical abnormality; measure the cellphone heat radiation; detect vascular changes; analysis of a blind reading; measure the percentage of abnormalities or disease's level (reference method); evaluate the burns and areas of skin; estimate the temperature distribution of the skin during and after physical exercise; inspect thermal insulation in buildings as well as in heat conducting pipes and flare detection; evaluate tumor growth; assist living at home: improving kitchen safety; and handle temperature for food processors.

In addition, the following list is provided to show the extensive applications found in the medical space. This list is provided as examples and is not limited to those provided below.

Medical Thermal Imaging Applications:

| | | |
|---|---|---|
| Altered Ambulatory Kinetics | Carpal Tunnel Syndrome | Grafts |
| Altered Biokinetics | Compartment Syndrome | Heart Disease |
| Brachial Plexus Injuries | Cord Pain/Injury | Hysteria |
| Biomechanical Impropriety | Deep Vein Thrombosis | Headache Evaluation |
| Breast Disease | Disc Disease | Herniated Disc |
| Bursitis | Dystrophy | Herniated Disc Pulposis |
| Inflammatory Disease | Facet Syndromes | Hyperaesthesia |
| Int. Carotid Insufficiency | Ext. Carotid Insufficiency | Hyperflexion Injury |
| Infectious Disease | Nerve Root Irritation | Reflex Symp. Dystrophy |
| Ligament Tear | Nerve Impingement | Ruptured Disc |
| Lower Motor Neuron Disease | Nerve Stretch Injury | Skin Cancer |
| Lumbosacral Plexus Injury | Neuropathy | Somatization Disorders |
| Malingering | Neurovascular Compression | Soft Tissue Injury |
| Median Nerve Neuropathy | Neuralgia | Sprain/Strain |
| Morton's Neuroma | Neuritis | Stroke Screening |
| Muscle Tear | Neuropraxia | Synovitis |
| Musculoigamentous Spasm | Neoplasia | Sensory Loss |
| Musculoigamentous Spasm | Nutritional Disease | Sensory Nerve Abnormality |
| Myofascial Irritation | Periodontal Disease | Skin Abnormalities |
| Nerve Entrapment | Peripheral Axon Disease | Somatic Abnormality |
| Nerve Impingement | Raynaud's | Superficial Vascular Disease |
| Nerve Pressure | Referred Pain Syndrome | Temporal Arteritis |
| Tendonitis | Trigeminal Neuroalgia | Ulnar Nerve Entrapment |

Color image quality measures have many practical applications, ranging from acquisition devices to communication systems. Practically, no-reference (NR) color image quality assessment is desirable because the reference images are not always accessible. The most widely recognized method of determining color image quality is the subjective evaluation mean opinion score (MOS). However, subjective evaluation is expensive with respect to time and resources, thus it is difficult to use in practical applications. Therefore, a reliable automatic objective color image quality measure, which is robust to distortion types and computationally efficient, is desirable.

In recent years, much effort has been made to develop objective image quality metrics that correlate with human visual perception. Various attempts to measure image attributes have been described. Some existing color image quality metrics focused on one aspect of color image qualities such as entropy, brightness, colorfulness, sharpness, and contrast: Y. Wang, et al., “Image enhancement based on equal area dualistic sub-image histogram equalization method,” Consumer Electronics, IEEE Transactions on, vol. 45, pp. 68-75, 1999. M. Kim and M. Chung, “Recursively separated and weighted histogram equalization for brightness preservation and contrast enhancement,” Consumer Electronics, IEEE Transactions on, vol. 54, pp. 1389-1397, 2008. S.-D. Chen and A. R. Ramli, “Minimum mean brightness error bi-histogram equalization in contrast enhancement,” Consumer Electronics, IEEE Transactions on, vol. 49, pp. 1310-1319, 2003. C. Wang and Z. Ye, “Brightness preserving histogram equalization with maximum entropy: a variational perspective,” Consumer Electronics, IEEE Transactions on, vol. 51, pp. 1326-1334, 2005. C. H. Ooi, et al., “Bi-histogram equalization with a plateau limit for digital image enhancement,” Consumer Electronics, IEEE Transactions on, vol. 55, pp. 2072-2080, 2009. D. Hasler and S. E. Suesstrunk, “Measuring colorfulness in natural images,” in Electronic Imaging 2003, 2003, pp. 87-95. B. Bringier, et al., “No-reference perceptual quality assessment of colour image,” in Proceedings of the European Signal Processing Conference (EUSIPCO'06), 2006. A. Maalouf and M. C. Larabi, “A no reference objective color image sharpness metric,” in EUSIPCO, 2010, pp. 1019-1022. Karen Panetta, Chen Gao, Sos Agaian, No Reference Color Image Contrast and Quality Measures, IEEE Transactions On Consumer Electronics, Volume 59 2013, Pages 643-651. Karen Panetta, Chen Gao, Sos Agaian, No Reference Color Image Quality Measures, Cybernetics (CYBCONF), 2013 IEEE International Conference on, 2013, Pages 243-248, B Silver, S Agaian, K Panetta, Logarithmic transform coefficient histogram matching with spatial equalization, Defense and Security, 2005, Pages 237-249.

Some additional approaches applied in this space are discussed now by providing the patent and application references.

In US 2011/0254952 A1 (Matthias Wagner) is introduced a method of using low-cost single-point infrared sensors or low-resolution infrared sensor arrays to generate a higher-resolution thermal image of the inspection subject.

In WO 2003011130 A2 (Miriam Oron, Moshe Yarden, Judith Zilberstein, Aharon Zrihen) is described a method for detecting a malignant lesion within a human tissue, comprising: (a) administering a thermal enhancing agent, and said thermal enhancing agent generates heat upon activation from an external energy source, to a human; (b) submitting the human tissue to a predetermined amount of energy emitted from an external energy source; (c) monitoring the temperature or other thermal magnitude on the skin on a plurality of points on the tissue; (d) analyzing the results of said monitoring; (e) detecting specific points on the tissue having abnormally higher temperatures or other thermal magnitudes, in comparison to other points on the tissue or to predetermined data.

In EP 0475570 A2 (Eldon Edward Cox, Jr., Michael Peter Rolla) is expressed a method and apparatus for indicating defects in manufactured products employs, instead of the conventional thermal image subtraction, “thermal ratio analysis”, which involves ratios of thermal data and their analysis including statistical analysis.

In WO 1998046976 A2 (Zhong Qi Liu, Chen Wang) is described a method and apparatus for thermal imaging is disclosed which enables a clinician to obtain visual images reflecting metabolic activity within a patient's body.

In WO 1998046976 A2 (David Lapidoth, Ehud Sela, Dror Sharon, Mordehay Reuven Canfi) is described a system for detecting and locating a thermal event and for providing a reaction to the detected thermal event is disclosed.

In EP 1383419 A1 (Joannis Pavlidis) is described a thermal image data of at least a region of a face of a person is provided. The thermal image data is transformed to blood flow rate data and any be used to determine whether the person is deceptive or non-deceptive based on the blood flow rate data, e.g., deceptive with respect to an elicited response from the person.

In US 20120307859 (Torsten Gogolla) A1 is described an imaging measuring system and measuring method for measuring thermal output to a target object an imaging thermographic measuring system to measure the thermal output at a target object, such as a building wall, building facade, or the like, comprising a measuring station provided for the arrangement distant from the object with an electric imaging device to record a thermographic thermal image, with a temperature distribution to be allocated thereto, and with a temperature sensor distant from the object to measure a temperature distant from the object; at least one thermal transition sensor provided to be arrange close to the object, a transmission arrangement to transmit values between at least one thermal transition sensor and the measuring station, with the thermal transition sensor being embodied to predetermine the test values to determine a thermal transition coefficient.

In EP 2282526 A2 (Shahin Baghai, Milton Bernard Hollander) is described a video scanner system and method wherein systems and methods are described for visualization and for display of remote surface measurement areas by capture of both visible and invisible views of image zones of an identified surface measurement area and the mutual display of visible and infrared views of thermal image zones with temperature indication across a panoramic view of the measured area by video.

In view of the foregoing, it is apparent that there exists a need in the art for systems and methods for image measurements particularly for thermal-image measurements that are reliable, automatic, and objective image quality measurements, which are robust to distortion types and computationally efficient. In addition, there currently is a need in the art to measure the quality of thermal images and videos.

### BRIEF SUMMARY OF THE INVENTION

The present invention, therefore, provides for systems and methods of using the same for image measurements particularly for thermal-image measurements that are reliable, automatic, and objective image quality measurements, which are robust to distortion types and computationally efficient.

The current invention relates to processing and analysis of image and video content:
Image/video processing (enhancement, color correction, segmentation, sharpening, warping, etc.))
Image/video analysis (image measurements and standardization)

In one embodiment, the present invention offers methods, systems, and devices to measure the quality of images and videos by combining several image quality components, including but not limited to brightness, darkness, density, and intensity, and more particularly to measures the quality of thermal images, or to evaluate image and video's brightness-darkness value.

In another embodiment, the present invention offers a method for determining the percentage of enhancement in thermal, infrared, color and gray scale images.

In yet another embodiment of the present invention are methods and systems, for multi-threshold systems for segmentation and color, and gray scale and thermal image enhancement.

In another embodiment, the present invention offers a method for measuring smaller degrees of change in images which may be used in many applications, including cameras, medical, systems maintenance, systems engineering, and etc.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a flowchart for the thermal image/video measuring and processing system in accordance with embodiments of the present disclosure;

FIG. 2 is a flowchart for the threshold application of the thermal image/video measuring and processing system in accordance with embodiments of the present disclosure;

FIG. 3 is a schematic illustration for the image enhancement-bi-segmentation method of the thermal image/video measuring and processing system in accordance with embodiments of the present disclosure;

FIG. 4 is a schematic illustration for the image enhancement-multi-segmentation method of the thermal image/video measuring and processing system in accordance with embodiments of the present disclosure;

FIG. 5 is a schematic of the nonlinear stretching image enhancement of the thermal image/video measuring and processing system in accordance with embodiments of the present disclosure;

FIG. 6 is a color thermal image dataset comparison illustrating the results of the thermal image/video measuring and processing system in accordance with embodiments of the present disclosure;

FIG. 7 is an infrared thermal image data set comparison illustrating the results of the thermal image/video measuring and processing system in accordance with embodiments of the present disclosure;

FIG. 8 is a fault detection application-motor problem comparison illustrating the results of the thermal image/video measuring and processing system in accordance with embodiments of the present disclosure;

FIG. 9 is a fault detection application-load problem comparison illustrating the results of the thermal image/video measuring and processing system in accordance with embodiments of the present disclosure;

FIG. 10 is a schematic of control system application of the thermal image/video measuring and processing system in accordance with embodiments of the present disclosure;

FIG. 11 is a schematic illustration of an application in fuzzy logic controller of the thermal image/video measuring and processing system in accordance with embodiments of the present disclosure;

FIG. 12 is a medical application directed towards breast cancer of the thermal image/video measuring and processing system in accordance with embodiments of the present disclosure;

FIG. 13 illustrates the electromagnetic spectrum in accordance with teachings of the present disclosure;

FIG. 14 illustrates measurements taken to capture cellphone radiation in accordance with teachings of the present disclosure;

FIG. 15 illustrates a segmentation application of the thermal image/video measuring and processing system in accordance with embodiments of the present disclosure;

FIG. 16 illustrates neurovascular reaction measurements taken in accordance with teachings of the present disclosure;

FIG. 17 is a nonlinear stretching image thermal image enhancement of the thermal image/video measuring and processing system in accordance with embodiments of the present disclosure;

FIG. 18 is a nonlinear stretching image enhancement of the thermal image/video measuring and processing system in accordance with embodiments of the present disclosure;

FIG. 19 is a nonlinear thermal stretching image enhancement of the thermal image/video measuring and processing system in accordance with embodiments of the present disclosure;

FIG. 20 is a cook-bake measurement system;

FIG. 21 is an earthquake prediction measure;

FIG. 22 is an application of detecting energy leaks in buildings and measuring their predictive maintenance of the thermal image/video measuring and processing system in accordance with embodiments of the present disclosure;

FIG. 23 is a multi-layer brightness-darkness decomposition in accordance with teachings of the present disclosure.

### DETAILED DESCRIPTION OF THE INVENTION

Disclosed herein are systems and methods of use for image measurements particularly for thermal-image measurements that are reliable, automatic, and objective image quality measurements, which are robust to distortion types and computationally efficient. The numerous innovative teachings of the present invention will be described with particular reference to several embodiments (by way of example, and not of limitation).

The following embodiments to be disclosed are discussed in the context of a computing device configuration. The computing device may be one of several devices such as but not limited to a workstation, laptop, mobile device, and/or personal computer. The computing device is comprised of a processor, a persistent storage medium for long term or non-volatile storage of programs or machine instructions, data, files, thermal images, thermal video, thermal frames, operating system, and other persistent information for carrying out the instructions and logic described herein. In some embodiments, storage may be higher latency than memory, but may characteristically have higher capacity. In other embodiments, a single hardware device may serve as both memory and storage.

### Embodiment 1

### Thermal Image Measurement

The current embodiment describes a system for measuring the enhancement of thermal images based on density and intensity characteristic of images. The system may be utilized on color and gray thermal images. The components and approaches of the system are:

A—Non-Reference Measuring System:

Definition 1—Density Function: Suppose that the image, I, is divided to K blocks. Total number of blocks is k₁×k₂ and it is assumed that the size of kth block is k×l. Consider the kth block (k=1, . . . , K) and sorting the density values and intensity of the mentioned blocks we have:

Pₘᵢₙ≦P₂≦P₃ . . . ≦P_{[T}_{_{k,l}}_{]}≦ . . . ≦Pₘₐₓ (1)

Xₘᵢₙ≦X₂≦X₃ . . . ≦X_{[T}_{_{k,l}}_{]}≦ . . . ≦Xₘₐₓ (2)

where Xᵢ, i=min . . . max, represent of image intensity values of the considered blocks described by Agaian, Roopaei, “New Haze Removal Scheme and Novel Measure of Enhancement”, IEEE international conference of cybernetics, pp 219-224 2013, is the nearest integer function and Pᵢ, i=min . . . max, is mass value which could be defined in different way as:

a) Density probability function: In this case, Pₖ is defined as:

$${P}_{k} = \frac{{n}_{k}}{N} .$$

k is the kth gray level, and nₖ is the total number of pixels in the image with gray level k and N is the total number of pixels.

b) Modified probability density function: In general the density probability function described previously, could be modified by a linear/non-linear function as: g(Pₖ). Where “g” is well defined linear/nonlinear function like what addressed by: Wang Bing-Jian and et al, “a real time contrast enhancement algorithm for infrared images based on plateau histogram” infrared physics & technology, pp 77-82, 2006 as plateau histogram:

$${P}_{k} = \{ \begin{matrix}{P}_{max} & {P}_{k} = {P}_{max} \\ {( \frac{{P}_{k}}{{P}_{max}} )}^{r} & 0 < {P}_{k} < {P}_{max} \\ 0 & {P}_{k} = 0\end{matrix}$$

c) Density value: Density value definition is: Pₖ=nₖ. k is the kth gray level, and nₖ is the total number of pixels in the image with gray level k.

By the above definition, the brightness and darkness have the following expressions:

$$\begin{matrix}{P}_{B ; k , l}^{ω} = {\sum }_{[ {T}_{k , l} ] + 1}^{max} {P}_{i} , {P}_{D ; k , l}^{ω} = {\sum }_{min}^{[ {T}_{k , l} ]} {P}_{i} & ( 3 ) \\ {I}_{B ; k , l}^{ω} = {\sum }_{[ {T}_{k , l} ] + 1}^{max} {X}_{i} , {I}_{D ; k , l}^{ω} = {\sum }_{min}^{[ {T}_{k , l} ]} {X}_{i} & ( 4 )\end{matrix}$$

P_{min;k,l}^{ω} and P_{max;k,l}^{ω} respectively are the minimum and maximum of density values inside the kth block. I_{min;k,l}^{ω} and I_{max;k,l}^{ω} respectively are the minimum and maximum of intensity values inside the kth block.

Definition 2: Cross Entropy Threshold

T_{k,l} is a threshold which is determined based on minimization of cross entropy between the darkness, P_{D;k,l}^{ω}, and brightness, P_{B;k,l}^{ω}, of the considered block which is expressed as:

$${T}_{k , l} = {Argmin}_{i = min}^{max} \{ {P}_{D ; k , l}^{ω} log \frac{{P}_{D ; k , l}^{ω}}{{P}_{B ; k , l}^{ω}} \} \qquad ( 5 )$$

It is noticeable that the threshold assigned could be assigned using existing methods or any new developed method.

According to definition 1 and 2, the general form of the described metric for non-reference thermal-image measurements of enhancement is defined as:

NTME=ƒ(P_{B;k,l}^{ω},P_{D;k,l}^{ω},I_{B;k,l}^{ω},P_{D;k,l}^{ω},P_{max;k,l}^{ω},P_{min;k,l}^{ω},I_{max;k,l}^{ω},I_{min;k,l}^{ω},T_{k,l}) (6)

Some of the unique aspects of the presented measure are the following characteristics:
a) Image dependent to the cross entropy threshold
b) Integration of both intensity and density
c) Applying concept of human visual system

Table 1 presents measures for thermal images quality assessments. Extensive computer simulation show that DMTE and DIMTE work for all thermal images however the rest are designed for just color thermal images. Integration of both intensity and density of thermal images are utilized.

TABLE 1
Definitions of the New Measures for Non-reference Thermal-Image Enhancement

| | | Color | Gray | Density- | Intensity |
|---|---|---|---|---|---|
| | | Thermal | Thermal | Based | Based |
| Measure | Illustrative Example | Images | Image | Measure | Measure |
| DMTE | $f ( I ) = \frac{1}{{k}_{1} {k}_{2}} {\sum }_{l = 1}^{{k}_{2}} {\sum }_{k = 1}^{{k}_{1}} \frac{{P}_{D ; k , l}^{ω }}{{P}_{B ; k , l}^{ω}} log \frac{{P}_{D ; k , l}^{ω}}{{P}_{B ; k , l}^{ω}}$ | ✓ | ✓ | ✓ | X |
| DIMTE | $f ( I ) = \frac{1}{{k}_{1} {k}_{2}} {\sum }_{l = 1}^{{k}_{2}} {\sum }_{k = 1}^{{k}_{1}} ( \frac{{p}_{m ax ; k , l}}{{p}_{m i n ; k , l}} ) \times {( \frac{{I}_{m ax ; k , l}}{{I}_{m i n ; k , l}} )}^{2}$ | ✓ | ✓ | ✓ | ✓ |
| MDIMTE | $f ( I ) = \frac{1}{{k}_{1} {k}_{2}} {\sum }_{l = 1}^{{k}_{2}} {\sum }_{k = 1}^{{k}_{1}} ( \frac{{P}_{D ; k , l}^{ω}}{{P}_{B ; k , l}^{ω}} ) {( \frac{{I}_{m ax ; k , l}^{ω}}{{I}_{m i n ; k , l}^{ω}} )}^{2}$ | ✓ | ✓ | ✓ | ✓ |
| CTM1 | $f ( I ) = \frac{1}{{k}_{1} {k}_{2}} {\sum }_{l = 1}^{{k}_{2}} {\sum }_{k = 1}^{{k}_{1}} log ( \frac{{I}_{m ax ; k , l}}{{I}_{m i n ; k , l}} ) \times {( \frac{{p}_{m a x ; k , l}}{{p}_{m i n ; k , l}} )}^{2}$ | ✓ | X | ✓ | ✓ |
| CTM2 | $f ( I ) = \frac{1}{{k}_{1} {k}_{2}} {\sum }_{l = 1}^{{k}_{2}} {\sum }_{k = 1}^{{k}_{1}} log ( {P}_{B ; k , l}^{ω} log ( \frac{{P}_{B ; k , l}^{ω}}{{P}_{D ; k , l}^{ω}} ) + {P}_{D ; k , l}^{ω} ( \frac{{P}_{D ; k , l}^{ω}}{{P}_{B ; k , l}^{ω}} ) ) \times {( \frac{{P}_{m ax ; k , l}}{{P}_{m i n ; k , l}} )}^{2}$ | ✓ | X | ✓ | X |

Logarithmic Model: The described measures can be equipped with the parametric logarithmic model [25, Karen Panetta, Sos Agaian, Yicong Zhou, Eric J Wharton, Parameterized logarithmic framework for image enhancement, Systems, Man, and Cybernetics, Part B: Cybernetics, IEEE Transactions, Volume 41, Pages 460-473, 2013; S. Nercessian, K. Panetta, and S. Agaian, “Multiresolution Decomposition Schemes Using The Parameterized Logarithmic Image Processing Model With Application To Image Fusion,” EURASIP Journal on Advances in Signal Processing, vol. 2011, p. 1, 2011]. The operators in the logarithmic model are defined as follows:

$${g}_{1} \dot{⊕} {g}_{2} = {g}_{1} + {g}_{2} - \frac{{g}_{1} {g}_{2}}{γ ( m )}$$

$${g}_{1} \dot{Θ} {g}_{2} = k ( m ) \frac{{g}_{1} - {g}_{2}}{k ( m ) - {g}_{2} + ɛ}$$

Where γ(m) and k(m) are two linear functions and “m” denotes the maximum value of pixel in the image,

By the above definition the ratio in Table 1 could be modified using the above definition. As an example, DMTE can be changed as:

$$D M T E = \frac{1}{{k}_{1} {k}_{2}} {\sum }_{l = 1}^{{k}_{2}} {\sum }_{k = 1}^{{k}_{1}} \frac{{P}_{D ; k , l}^{ω} \dot{Θ} {P}_{B ; k , l}^{ω}}{{P}_{D ; k , l}^{ω} \dot{⊕} {P}_{B ; k , l}^{ω}} log \frac{{P}_{D ; k , l}^{ω} \dot{Θ} {P}_{B ; k , l}^{ω}}{{P}_{D ; k , l}^{ω} \dot{⊕} {P}_{B ; k , l}^{ω}} \qquad ( 7 )$$

B—Reference Measuring System:

All the methods described in the previous section are based on an image, I. In other words, all the relations (1)-(7) are functions with the variable I as their argument. Next the reference-base thermal-image measure of enhancement is introduced.

In the reference-base measuring the quality of an image is calculated in accordance with the original image. Assume that the original and the enhanced image are called I_{org} and I respectively. Therefore all definitions in the previous section are reasonable for the I_{org} as:

$$\begin{matrix}{P}_{Org , B ; k , l}^{ω} = {\sum }_{{T}_{k , l} + 1}^{max} {P}_{org , i} , {P}_{D ; k , l}^{ω} = {\sum }_{min}^{{T}_{k , l}} {P}_{org , i} & ( 8 ) \\ {I}_{org , B ; k , l}^{ω} = {\sum }_{{T}_{k , l} + 1}^{max} {X}_{org , i} , {I}_{D ; k , l}^{ω} = {\sum }_{min}^{{T}_{k , l}} {X}_{org , i} & ( 9 )\end{matrix}$$

P_{org,min;k,l}^{ω} and P_{org,max;k,l}^{ω} respectively are the minimum and maximum of density values inside the kth block. I_{org,min;k,□}^{ω} and P_{org,max;k,l}^{ω} respectively are the minimum and maximum of intensity values inside the kth block of the original image. By the mentioned explanation the reference measuring system could be defined by modifying Table 1 as follows:

TABLE 2
Definitions of the New Measures for Reference Thermal-Image Enhancement

| | | Color | Gray | Density- | Intensity |
|---|---|---|---|---|---|
| | | Thermal | Thermal | Based | Based |
| Measure | Illustrative Example | Images | Image | Measure | Measure |
| DMTE | $f ( {I}_{org} , I ) = \frac{1}{{k}_{1} {k}_{2}} {\sum }_{l = 1}^{{k}_{2}} {\sum }_{k = 1}^{{k}_{1}} \frac{{P}_{D ; k , l}^{ω}}{{P}_{org , D ; k , l}^{ω}} log \frac{{P}_{B ; k , l}^{ω}}{{P}_{org , B ; k , l}^{ω}}$ | ✓ | ✓ | ✓ | X |
| DIMTE | $f ( {I}_{org} , I ) = \frac{1}{{k}_{1} {k}_{2}} {\sum }_{l = 1}^{{k}_{2}} {\sum }_{k = 1}^{{k}_{1}} ( \frac{{p}_{m ax ; k , l}}{{p}_{org , m ax ; k , l}} ) \times {( \frac{{I}_{m ax ; k , l}}{{I}_{org , m ax ; k , l}} )}^{2}$ | ✓ | ✓ | ✓ | ✓ |
| MDIMTE | $f ( {I}_{org} , I ) = \frac{1}{{k}_{1} {k}_{2}} {\sum }_{l = 1}^{{k}_{2}} {\sum }_{k = 1}^{{k}_{1}} ( \frac{{P}_{D ; k , l}^{ω}}{{P}_{org , D ; k , l}^{ω}} ) {( \frac{{I}_{m ax ; k , l}^{ω}}{{I}_{org , m ax ; k , l}^{ω}} )}^{2}$ | ✓ | ✓ | ✓ | ✓ |
| CTM1 | $f ( {I}_{org} , I ) = \frac{1}{{k}_{1} {k}_{2}} {\sum }_{l = 1}^{{k}_{2}} {\sum }_{k = 1}^{{k}_{1}} log ( \frac{{I}_{m ax ; k , l}}{{I}_{org , m ax ; k , l}} ) \times {( \frac{{p}_{m ax ; k , l}}{{p}_{org , m ax ; k , l}} )}^{2}$ | ✓ | X | ✓ | ✓ |
| CTM2 | $f ( {I}_{org} , I ) = \frac{1}{{k}_{1} {k}_{2}} {\sum }_{l = 1}^{{k}_{2}} {\sum }_{k = 1}^{{k}_{1}} log ( {P}_{B ; k , l}^{ω} log ( \frac{{P}_{B ; k , l}^{ω}}{{P}_{org , D ; k , l}^{ω}} ) + {P}_{D ; k , l}^{ω} log ( \frac{{P}_{D ; k , l}^{ω}}{{P}_{org , B ; k , l}^{ω}} ) ) \times {( \frac{{p}_{m ax ; k , l}}{{p}_{org , m ax ; k , l}} )}^{2}$ | ✓ | X | ✓ | X |

In general form the reference thermal-image measure of enhancement is expressed as:

RTME=g(I_{org},I) (10)

where ‘g” is well-defined linear/non-linear function. I_{org} and, I are arguments of “g” function which can also be modified as by the following arguments:

TABLE 3
Definitions of the new kind of variables
for described measuring system

g(log (I_{org}),log (I))
g(log (log (I_{org})),log (log (I)))
g((I_{org})^{α},(I)^{β})

The threshold mechanism for the reference-base measuring system could be modified as follows:

$$\begin{matrix}{T}_{D , k , l} = {Argmin}_{i = min}^{max} \{ {P}_{Dlk , l}^{ω} log \frac{{P}_{D ; k , l}^{ω}}{{P}_{org , D ; k , l}^{ω}} \} & ( 11 ) \\ {T}_{B , k , l} = {Argmin}_{i = min}^{max} \{ {P}_{B ; k , l}^{ω} log \frac{{P}_{B ; k , l}^{ω}}{{P}_{org , B ; k , l}^{ω}} \} & ( 12 )\end{matrix}$$

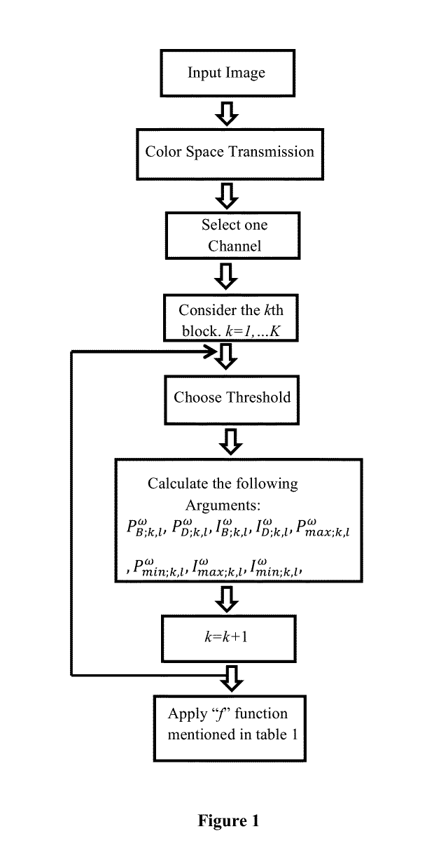

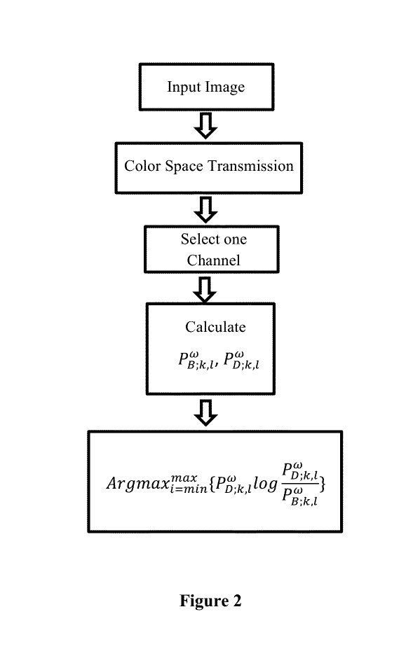

The final threshold is the average of T_{D,k,l} and T_{B,k,l}. The threshold for both reference and non-reference measuring system could be defined using existing methods or any new method. The flowchart for the thermal measuring system and threshold are illustrated in FIG. 1 and FIG. 2 respectively.

### Embodiment 2

### Multilevel Theresholding Method

The second embodiment describes a system to make multilevel thresholds. Image thresholding is widely used as a popular tool in image segmentation. It is useful to separate objects from background, or discriminate objects from objects that have distinct grey levels. Thresholding involves bi-level thresholding and multilevel thresholding. Bi-level thresholding classifies the pixels into two groups, one including those pixels with grey levels above a certain threshold, the other including the rest. Multilevel thresholding divides the pixels into several classes. The pixels belonging to the same class have grey levels within a specific range defined by several thresholds (P. D. Sathya, R. Kayalvizhi, PSO-Based Tsallis Thresholding Selection Procedure for Image Segmentation, International Journal of Computer Applications (0975-8887) Volume 5-No. 4, August 2010).

The system utilizes multilevel thresholding based on cross entropy for color and gray images. The structure of the system are: consider a density spectrum of an image block as defined in (1). To span the density interval to m+1 interval the relation (3) could be modified as:

$${P}_{1 ; k , l}^{ω} = {\sum }_{min}^{[ {t}_{1 , k , l} ]} {P}_{i} , \\ {P}_{2 ; k , l}^{ω} = {\sum }_{[ {t}_{1 , k , l} ]}^{[ {t}_{2 , k , l} ]} {P}_{i} , … , {P}_{m ; k , l}^{ω} = {\sum }_{[ {t}_{m , k , l} ]}^{max} {P}_{i} , {P}_{m + 1 ; k , l}^{ω} = {\sum }_{{t}_{m + 1 , k , l}}^{max} {P}_{i} \qquad ( 13 )$$

To decompose the density span to the mentioned intervals it needs to define “m” thresholds. Therefore the threshold in (5) should be modified as follows:

$${T}_{1 , k , l} = Argmin \{ {P}_{1 ; k , l}^{ω} log \frac{{P}_{1 ; k , l}^{ω}}{{\sum }_{i = 2}^{m + 1} {P}_{i ; k , l}^{ω}} \} \\ {T}_{2 , k , l} = Argmin \{ {P}_{2 ; k , l}^{ω} log \frac{{P}_{2 ; k , l}^{ω}}{{\sum }_{i = 1 , i \neq 2}^{m + 1} {P}_{i ; k , l}^{ω}} \} \\ ⋮ \\ {T}_{m , k , l} = Argmin \{ {P}_{m ; k , l}^{ω} log \frac{{P}_{m ; k , l}^{ω}}{{\sum }_{i = 1 , i \neq m}^{m + 1} {P}_{i ; k , l}^{ω}} \} \qquad ( 14 )$$

The represented thresholding method could be used in general form for decomposing an image to the m+1's classes.

To find the thresholds from the above relations, any optimization method like Genetic Algorithm could be applied.

### Embodiment 3

### Brightness-Darkness Measure

A third embodiment determines the level of darkness or brightness in color or gray scale images. Brightness and darkness are attributes of a visual sensation according to where a given visual stimulus appears to be more or less intense, or according to which the area in which the visual stimulus is presented, and/or appears to emit more or less light. The structures of the system are:

DMTE, designed based on the threshold system represented in the previous section, could be defined as a new brightness-darkness measuring system:

$$B D M S = \frac{1}{{k}_{1} {k}_{2}} {\sum }_{l = 1}^{{k}_{2}} {\sum }_{k = 1}^{{k}_{1}} \frac{{P}_{D ; k , l}^{ω}}{{P}_{B ; k , l}^{ω}} log \frac{{P}_{D ; k , l}^{ω}}{{P}_{B ; k , l}^{ω}} \qquad ( 15 )$$

According to the logarithmic operators expressed in the first embodiment, BDMS could be modified as:

$$B D M S = \frac{1}{{k}_{1} {k}_{2}} {\sum }_{l = 1}^{{k}_{2}} {\sum }_{k = 1}^{{k}_{1}} {P}_{D ; k , l}^{ω} \dot{Θ} \frac{{P}_{D ; k , l}^{ω} \dot{Θ} {P}_{B ; k , l}^{ω}}{{P}_{D ; k , l}^{ω} \dot{⊕} {P}_{B ; k , l}^{ω}} \qquad ( 16 )$$

The described metric for measuring brightness and darkness level could be applied as a reference method defined as:

$$B D M S = \frac{1}{{k}_{1} {k}_{2}} {\sum }_{l = 1}^{{k}_{2}} {\sum }_{k = 1}^{{k}_{1}} \frac{{P}_{D ; k , l}^{ω}}{{P}_{org , D ; k , l}^{ω}} log \frac{{P}_{D ; k , l}^{ω}}{{P}^{{ω}^{org , D ; k , l}}} \qquad ( 17 )$$

To determine the brightness and darkness in specific range: r, the multilevel thresholding system could be applied and the modified brightness-darkness measure is defined as:

$$B D M S ( r ) = \frac{1}{{k}_{1} {k}_{2}} {\sum }_{l = 1}^{{k}_{2}} {\sum }_{k = 1}^{{k}_{1}} \frac{{P}_{r ; k , l}^{ω}}{{\sum }_{i = 2}^{m + 1} {P}_{i ; k , l}^{ω}} log \frac{{P}_{r ; k , l}^{ω}}{{\sum }_{i = 1}^{m + 1} {P}_{i ; k , l}^{ω}} \qquad ( 18 )$$

Where “m’ is the total number of thresholds assigned on the intensity interval of the image.

### Embodiment 4

### Segmentation

The forth embodiment represents a segmentation method. Image segmentation is a critical task in automatic image analysis and a fundamental step of low-level vision which provides important information for further image understanding. In many image analysis applications, it is often the first and most important and most difficult step. Due to its importance, a great variety of segmentation approaches have been described in the last few decades for a wide range of applications and domains. Medical image analysis received considerable attention from researchers due to its practical and vital applications for human health (Cristian Smochin\check{a}, “Image Processing Techniques And Segmentation Evaluation”, doctoral thesis, Technical University “gheorghe asachi” ia [symbol] i)

Thresholding is the simplest segmentation method. The pixels are partitioned depending on their intensity value. Global thresholding, using an appropriate threshold T is:

$$I ( x , y ) = \{ \begin{matrix}1 & I ( x , y ) > T \\ 0 & I ( x , y ) < T\end{matrix}$$

If T can change over an image is called variable thresholding, however local or regional thresholding happens if T depends on a neighborhood of (x, y). In that case T is a function of (x, y) and is known as Adaptive thresholding. The above relation for multiple thresholding is:

$$I ( x , y ) = \{ \begin{matrix}a & I ( x , y ) > {T}_{2} \\ b & {T}_{1} < I ( x , y ) < {T}_{2} \\ c & {T}_{1} < I ( x , y )\end{matrix}$$

The described thresholding system in the previous section could be used as a segmentation method. Comparison shows that the represented segmentation method has better performance over the Otsu[ ] algorithm.
By the innovated multilevel thresholding system, the image could be decomposed to m+1 class as:

$$I ( x , y ) = \{ \begin{matrix}{m}_{1} & I ( x , y ) < {T}_{1} \\ {m}_{2} & {T}_{1} < I ( x , y ) < {T}_{2} \\ ⋮ & ⋮ \\ {m}_{k + 1} & {T}_{m} < I ( x , y )\end{matrix} \qquad ( 19 )$$

Where Tᵢ, i=1, . . . , m could be obtained from the relation

### Embodiment 5

### Image Enhancement

In a fifth embodiment, image enhancement devices and image enhancement methods are provided. Contrast is the difference in visual properties that makes an object (or its representation in an image) distinguishable from other objects and the background. In visual perception of the real world, contrast is determined by the difference in the color and brightness of the object and other objects within the same field of view. Contrast enhancement is one of the image enhancement techniques to enhance the contrast present in an image based on a contrast curve. Global contrast enhancement is to uniformly adjust the contrast of each pixel of the image according to a global contrast curve. According to the innovated multi threshold system, two structures are described for thermal image enhancement as follows:

1—Image Enhancement-Bi-Segmentation Method

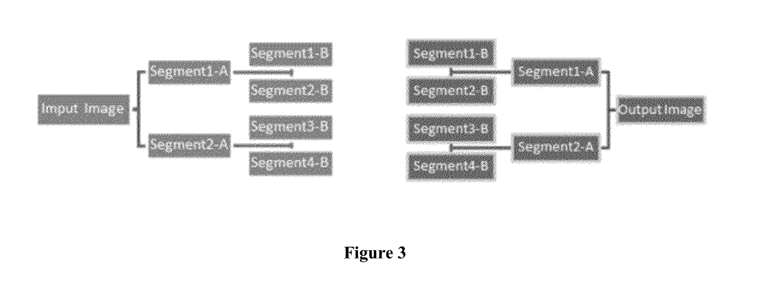

In the described enhancement method the input image is decomposed into two segments to create the first layer. The second layer is constructed by making two other segments based on the made images of the layer 1. This procedure could be continued based on the desired enhancement level. In FIG. 3 there are 2 layers: A and B considered for decomposition. The enhancement scheme would be considered later.

2—Image Enhancement-Multi-Segmentation Method

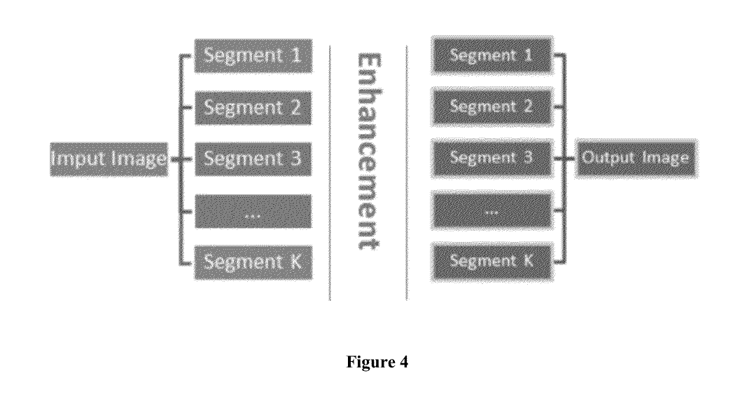

In the second enhancement structure the image is decomposed in just one step based on the multi-thresholds system explained in the previous sections. The number of segmentations depends on the level of enhancement where the enhancement algorithm would be expressed later. The structure of this enhancement scheme is illustrated in FIG. 4.

3—Nonlinear Stretching Image Enhancement

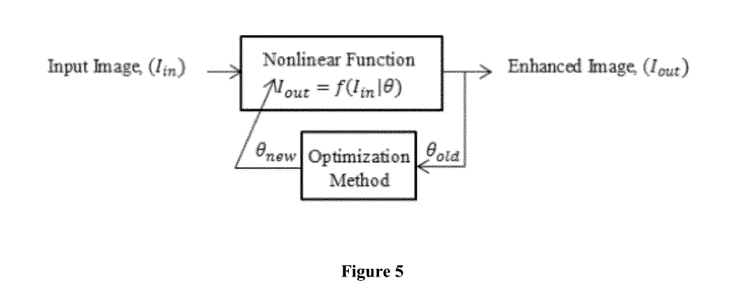

In the innovative method, nonlinear functions are used for mapping the intensity value of an image. The block diagram is depicted in FIG. 5 wherein nonlinear function “ƒ” can be defined in different way (see formulation (20) and (21))

Description of the Innovative Method:

The innovative method addresses stretching functions for color and gray image enhancement. The inherent characteristic of the innovative functions allow them to have superior performances over the existing methods. Functions have been inspired from human visual system and set of adjustable parameters with soft computing methods attempt to enhance the image in each iteration. Partially logarithmic and sigmoidal functions as illustrative examples are innovated and the simulation results show the effectiveness of both in color and gray image enhancement in comparison with wee known NASA Retinex Method.

A—Logarithmic Nonlinear function

$${I}_{out} = \frac{log ( 1 + … log ( 1 + \vert log ( 1 + μ \vert {I}_{in} - α \vert ) \vert )}{lo \underbrace{g ( 1 + … log ( 1 + \vert log (}_{n} 1 + \vert {I}_{in} - β \vert ) \vert )} \qquad ( 20 )$$

Where in the above relation, Iᵢₙ is the intensity input image and Iₒᵤₜ is the enhanced output image. The parameters α, β and μ are obtained by any existing optimization algorithm like Genetic Algorithm (GA) or any developing method in such a way that an enhancement measure is satisfied.

B—Nonlinear Sigmoidal Function

A sigmoid function is a mathematical function having an “S” shape (sigmoid curve). Often, sigmoid function refers to the special case of the logistic function shown below and defined by the formula:

$$Sigm ( x , μ ) = \frac{1}{1 + {e}^{- ( x - μ )}}$$

In the above relation μ is the center of sigmoid function. The mapping function could be as a combination of sigmoid function as:

$${I}_{out} = \frac{{\sum }_{i = 1}^{n} {γ}_{i} sigm ( {I}_{in} , {α}_{i} )}{{\sum }_{j = 1}^{m} {γ}_{j} sigm ( {I}_{in} , {α}_{j} )} \qquad ( 21 )$$

Where αᵢ, αⱼ, i={1, 2, . . . , n}, j={1, 2, . . . , m}, are the intensity values in the interval and γᵢ and γⱼ are constants which could be optimized based on GA.

### Embodiment 6

### Image Fusion Measurement

The sixth embodiment proposes an Image Fusion Measurement (IFM). Image fusion is a process of combining images, obtained by sensors of different wavelengths simultaneously viewing the same scene, to form a composite image. The composite image is formed to improve image content and to make it easier for the user to detect, recognize, and identify targets and increase his situational awareness (Firooz Sadjadi, “Comparative Image Fusion Analysais” 2005 IEEE Computer Society Conference on Computer Vision and Pattern Recognition). The structures of the invented system are:

Consider Iᵢ, i=1, . . . , n, are images which are going to be fused. The achieved image after fusion called I_{ƒ} According the previous definition and based on Darkness and Brightness expressed in embodiment 1, the degree of dependency of image, Iᵢ, and the fused images is defined as:

$$I F M ( {I}_{i} , {I}_{f} ) = f ( {P ( {I}_{i} )}_{D ; k , l}^{ω} , {P ( {I}_{i} )}_{B ; k , l}^{ω} , {P ( {I}_{i} )}_{max ; k , l}^{ω} , {P ( {I}_{f} )}_{D ; k , l}^{ω} , {P ( {I}_{f} )}_{max ; k , l}^{ω} , {P ( {I}_{f} )}_{B ; k , l}^{ω} , {I ( {I}_{i} )}_{max ; k , l}^{ω} , {I ( {I}_{f} )}_{max ; k , l}^{ω} ) \qquad ( 22 )$$

In the above relation, function “ƒ” is a nonlinear function which could be include of the following as:

TABLE 3
Fusion measurement
Illustrative Example
${IFM}_{1} \text{:} f ( {I}_{1} , {I}_{f} ) = \frac{1}{{k}_{1} {k}_{2}} {\sum }_{l = 1}^{{k}_{2}} {\sum }_{k = 1}^{{k}_{1}} \frac{{P ( {I}_{i} )}_{D ; k , l}^{ω}}{{P ( {I}_{f} )}_{D ; k , l}^{ω}} log \frac{{P ( {I}_{i} )}_{B ; k , l}^{ω}}{{P ( {I}_{f} )}_{B ; k , l}^{ω}}$
${IFM}_{2} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} ( \frac{{P ( {I}_{i} )}_{m ax ; k , l}}{{P ( {I}_{f} )}_{m ax ; k , l}^{ω}} ) \times {( \frac{{I ( {I}_{i} )}_{m ax ; k , l}}{{I ( {I}_{f} )}_{m ax ; k , l}} )}^{2}$
${IFM}_{3} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} ( \frac{{P ( {I}_{i} )}_{D ; k , l}^{ω}}{{P ( {I}_{f} )}_{D ; k , l}^{ω}} ) {( \frac{{I ( {I}_{i} )}_{m ax ; k , l}^{ω}}{{I ( {I}_{f} )}_{m ax ; k , l}^{ω}} )}^{2}$
${IFM}_{4} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} log ( \frac{{I ( {I}_{i} )}_{m ax ; k , l}}{{I ( {I}_{f} )}_{m ax ; k , l}} ) \times {( \frac{{P ( {I}_{i} )}_{m ax ; k , l}}{{P ( {I}_{f} )}_{m ax ; k , l}^{ω}} )}^{2}$
${IFM}_{5} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} log ( {P ( {I}_{i} )}_{B ; k , l}^{ω} log ( \frac{{P ( {I}_{i} )}_{B ; k , l}^{ω}}{{P ( {I}_{f} )}_{D ; k , l}^{ω}} ) + {P ( {I}_{i} )}_{D ; k , l}^{ω} log ( \frac{{P ( {I}_{i} )}_{D ; k , l}^{ω}}{{P ( {I}_{f} )}_{D ; k , l}^{ω}} ) ) \times {( \frac{{p ( {I}_{i} )}_{m ax ; k , l}}{{P ( {I}_{f} )}_{D ; k , l}^{ω}} )}^{2}$

According to the logarithmic operators expressed in the first embodiment, IFM's could be modified. For example, IFM₁ is changed as:

$$I F M I {M}_{1} = \frac{1}{{k}_{1} {k}_{2}} {\sum }_{l = 1}^{{k}_{2}} {\sum }_{k = 1}^{{k}_{1}} \frac{{P ( {I}_{i} )}_{D ; k , l}^{ω} \dot{Θ} {P ( {I}_{i} )}_{B ; k , l}^{ω}}{{P ( {I}_{f} )}_{D ; k , l}^{ω} \dot{⊕} {P ( {I}_{f} )}_{B ; k , l}^{ω}} log \frac{P {( {I}_{i} )}_{D ; k , l}^{ω} \dot{Θ} {P ( {I}_{i} )}_{B ; k , l}^{ω}}{{P ( {I}_{f} )}_{D ; k , l}^{ω} \dot{⊕} {P ( {I}_{f} )}_{B ; k , l}^{ω}} \qquad ( 23 )$$

To measure how much of the salient information contained in original images (Iᵢ=1, . . . , n) has been transformed into the fused image innovating measurement are described as follows:

TABLE 4
Transferred Information-Fusion measurement
Illustrative Example
${IFM}_{1} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} \frac{{\sum }_{1}^{n} {P ( {I}_{i} )}_{D ; k , l}^{ω}}{{P ( {I}_{f} )}_{D ; k , l}^{ω}} log \frac{{\sum }_{1}^{n} {P ( {I}_{i} )}_{B ; k , l}^{ω}}{{P ( {I}_{f} )}_{B ; k , l}^{ω}}$
${IFM}_{2} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} ( \frac{{\sum }_{1}^{n} {P ( {I}_{i} )}_{m ax ; k , l}}{{P ( {I}_{f} )}_{m ax ; k , l}^{ω}} ) \times {( \frac{{\sum }_{1}^{n} {I ( {I}_{i} )}_{m ax ; k , l}}{{I ( {I}_{f} )}_{m ax ; k , l}^{ω}} )}^{2}$
${IFM}_{3} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} ( \frac{{\sum }_{1}^{n} {P ( {I}_{i} )}_{D ; k , l}^{ω}}{{P ( {I}_{f} )}_{D ; k , l}^{ω}} ) {( \frac{{\sum }_{1}^{n} {I ( {I}_{i} )}_{m ax ; k , l}}{{I ( {I}_{f} )}_{m ax ; k , l}^{ω}} )}^{2}$
${IFM}_{4} \text{:} f ( {I}_{i} , {I}_{f} ) = \frac{1}{{k}_{1} {k}_{2}} {\sum }_{l = 1}^{{k}_{2}} {\sum }_{k = 1}^{{k}_{1}} log ( \frac{{\sum }_{1}^{n} {I ( {I}_{i} )}_{m ax ; k , l}}{{I ( {I}_{f} )}_{m ax ; k , l}} ) \times {( \frac{{\sum }_{1}^{n} {P ( {I}_{i} )}_{D ; k , l}^{ω}}{{P ( {I}_{f} )}_{m ax ; k , l}^{ω}} )}^{2}$
$\frac{1}{{k}_{1} {k}_{2}} {\sum }_{l = 1}^{{k}_{2}} {\sum }_{k = 1}^{{k}_{1}} log ( \begin{matrix}{\sum }_{1}^{n} {P ( {I}_{i} )}_{B ; k , l}^{ω} log ( \frac{{\sum }_{1}^{n} {P ( {I}_{i} )}_{B ; k , l}^{ω}}{{P ( {I}_{f} )}_{D ; k , l}^{ω}} ) + \\ {\sum }_{1}^{n} {P ( {I}_{i} )}_{D ; k , l}^{ω} log ( \frac{{\sum }_{1}^{n} {P ( {I}_{i} )}_{D ; k , l}^{ω}}{{P ( {I}_{f} )}_{D ; k , l}^{ω}} )\end{matrix} ) \times {( \frac{{p ( {I}_{i} )}_{m ax ; k , l}}{{P ( {I}_{f} )}_{D ; k , l}^{ω}} )}^{2}$

### Embodiment 7

### Color Image Brightness-Darkness Measurement

In the seventh embodiment is an innovated measure for brightness and darkness of color images. At first the RGB color space is transformed to CIE L*a*b color space. Second, the color components of the new space, “a” and “b” is selected. The final step is applying two-dimensional histogram on the reduced color space considering the concept of brightness-darkness introduced at embodiment 1.

Gray Scale Image Brightness-Darkness

The represented measure of brightness-darkness in embodiment 3 could be improved based on using two-dimensional histogram as follows:

Two-Dimensional Histogram:

(Jun Zhang, Jinglu Hu, “Image Segmentation Based On 2D Otsu Method With Histogram Analysis” international conference on computer science and software engineering, pp 105-108, 2008) An image with size M×N can be represented by a 2D gray level intensity function I(i, j). The value of I(i, j) is the gray level, ranging from 0 to L−1, where L is the number of distinct gray levels. In a 2D thresholding method, the gray level of a pixel and its local average gray level are both used. The local average gray level is also divided into the same L values, let Ĩ(i, j) be the function of the local average gray level, then:

$$\tilde{I} ( i , j ) = \frac{1}{{n}^{2}} {\sum }_{x = - n / 2}^{n / 2} {\sum }_{y = - n / 2}^{n / 2} I ( i + x , j + y ) \qquad ( 24 )$$

Where n≦min{M, N}.

The relation (24) is weighted local average but it could be represented in more general form as high-pass filter, low-pass filter or any other nonlinear function applied to the image to make the new image as follows:

$$\tilde{I} ( i , j ) = \frac{1}{{n}^{2}} {\sum }_{x} {\sum }_{y} f ( I , i , j , x , y ) \qquad ( 25 )$$

Let rᵢⱼ be the total number of occurrence of the pair (x, y) which represents pixel (i, j) with I(i, j)=x and Ĩ(i, j)=y, 0≦rᵢⱼ≦M×N, then the 2D histogram of the image pᵢⱼ is given by:

$${p}_{ij} = \frac{{r}_{ij}}{M \times N} i , j = 0 , … , L - 1 , {\sum }_{i = 0}^{L - 1} {\sum }_{j = 0}^{L - 1} {p}_{ij} = 1 \qquad ( 26 )$$

Now suppose that the pixels are portioned into two classes by a threshold pair(a, r) which extracted from the innovated threshold system expressed in embodiment 2 applied on I(i, j) and Ĩ(i, j) respectively. The brightness and darkness measure based on 2D histogram defines as:

$${P}_{B} ( a , r ) = {\sum }_{i = 0}^{a} {\sum }_{j = 0}^{r} {p}_{ij}$$

$${P}_{D} ( a , r ) = {\sum }_{i = a + 1}^{L - 1} {\sum }_{j = r + 1}^{L - 1} {p}_{ij}$$

According to the above definition, the measure of enhancement for thermal images, brightness-darkness, fusion and segmentation based on 2D histogram is defined as:

$$2 D Image Measurement = h ( {P}_{B} ( a , r ) , {P}_{B} ( a , r ) , {p}_{max ; k , l}^{ω} , {p}_{i , {j}_{min ; k , l}}^{ω} , {I}_{max ; k , l} , {I}_{min ; k , l} ) \\ 2 D H I M E = \frac{1}{{k}_{1} {k}_{2}} {\sum }_{l = 1}^{{k}_{2}} {\sum }_{k = 1}^{{k}_{1}} \frac{{{P}_{D} ( a , r )}_{; k , l}^{ω}}{{{P}_{B} ( a , r )}_{; k , l}^{ω}} log \frac{{{P}_{D} ( a , r )}_{; k , l}^{ω}}{{{P}_{B} ( a , r )}_{; k , l}^{ω}} \qquad ( 27 )$$

TABLE 5
Brightness-Darkness Measurment
Illustrative Example
$h ( I ) = \frac{1}{{k}_{1} {k}_{2}} {\sum }_{l = 1}^{{k}_{2}} {\sum }_{k = 1}^{{k}_{1}} \frac{{{P}_{D} ( a , r )}_{; k , l}^{ω}}{{{P}_{B} ( a , r )}_{; k , l}^{ω}} log \frac{{{P}_{D} ( a , r )}_{; k , l}^{ω}}{{{P}_{B} ( a , r )}_{; k , l}^{ω}}$
$h ( I ) = \frac{1}{{k}_{1} {k}_{2}} {\sum }_{l = 1}^{{k}_{2}} {\sum }_{k = 1}^{{k}_{1}} ( \frac{{p}_{{ij}_{m ax ; k , l}}^{ω}}{{p}_{{ij}_{m i n ; k , l}}^{ω}} ) \times {( \frac{{I}_{m ax ; k , l}}{{I}_{m i n ; k , l}} )}^{2}$
$h ( I ) = \frac{1}{{k}_{1} {k}_{2}} {\sum }_{l = 1}^{{k}_{2}} {\sum }_{k = 1}^{{k}_{1}} ( \frac{{{P}_{D} ( a , r )}_{; k , l}^{ω}}{{{P}_{B} ( a , r )}_{; k , l}^{ω}} ) {( \frac{{I}_{m ax ; k , l}^{ω}}{{I}_{m i n ; k , l}^{ω}} )}^{2}$
$h ( I ) = \frac{1}{{k}_{1} {k}_{2}} {\sum }_{l = 1}^{{k}_{2}} {\sum }_{k = 1}^{{k}_{1}} log ( \frac{{I}_{m ax ; k , l}}{{I}_{m i n ; k , l}} ) \times {( \frac{{p}_{{ij}_{m ax ; k , l}}^{ω}}{{p}_{{ij}_{m ax ; k , l}}^{ω}} )}^{2}$
$h ( I ) = \frac{1}{{k}_{1} {k}_{2}} {\sum }_{l = 1}^{{k}_{2}} {\sum }_{k = 1}^{{k}_{1}} log ( \begin{matrix}{{P}_{D} ( a , r )}_{; k , l}^{ω} log ( \frac{{{P}_{B} ( a , r )}_{; k , l}^{ω}}{{{P}_{D} ( a , r )}_{; k , l}^{ω}} ) + \\ {{P}_{B} ( a , r )}_{; k , l}^{ω} log ( \frac{{{P}_{D} ( a , r )}_{; k , l}^{ω}}{{{P}_{B} ( a , r )}_{; k , l}^{ω}} )\end{matrix} ) \times {( \frac{{p}_{{ij}_{m ax ; k , l}}^{ω}}{{p}_{{ij}_{m i n ; k , l}}^{ω}} )}^{2}$

Color Image Brightness-Darkness Measurement

The color space should be transformed from RGB to CIE L*a*b color Space. The transformed color space is defined as: CIE L*a*b color Space: is designed to approximate human vision (the L component closely matches human perception of lightness or it can be used to adjust the lightness contrast using the L component); and the “a” and “b” components can be used to make accurate color balance corrections. In other words, the L*a*b color space with Dimension L that represents the lightness of the color, Dimension “a” that represents its position between red/magenta and green and Dimension “b” that represents its position between yellow and blue. Due to its perceptual uniformity, L*a*b produces a proportional change visually for a change of the same amount in color value. This ensures that every minute difference in the color value gets noticed visually. The color axes are based on the fact that a color can't be both red and green, or both blue and yellow, because these colors oppose each other. On each axis the values run from positive to negative. Therefore, values are only needed for two color axes (unlike in RGB, CMY or XYZ where lightness depends on relative amounts of the three color channels). After color transformation the “a” and “components are selected and two images I(i, j) and Ĩ(i, j) are created. Let rᵢⱼ be the total number of occurrence of the pair (x, y) which represents pixel (i, j) with I(i, j)=x and Ĩ(i, j)=y, 0≦rᵢⱼ≦M×N, then the 2D histogram of the image pᵢⱼ is given by:

$${p}_{ij} = \frac{{r}_{ij}}{M \times N} , i , j = 0 , … , L - 1 , {\sum }_{i = 0}^{L - 1} {\sum }_{j = 0}^{L - 1} {p}_{ij} = 1$$

Based on a two-dimensional histogram expressed previously, the brightness-darkness relations are defined as:

P_{B}(I,Ĩ,a,r)=Σᵢ₌₀^{a}Σⱼ₌₀^{r}pᵢⱼ (28)

P_{D}(I,Ĩ,a,r)=Σᵢ₌ₐ₊₁^{L-1}Σⱼ₌ᵣ₊₁^{L-1}pᵢⱼ (29)

Let the distance between the mentioned images defined as: D(I, Ĩ). Therefore the brightness-darkness measure for color image is defined as:

$${[ {\sum }_{i = 1}^{M} {\sum }_{j = 1}^{N} {( {I}_{ij} - {\tilde{I}}_{ij} )}^{2} ]}^{1 / 2} \times \frac{{P}_{D} ( I , \tilde{I} , a , r )}{{P}_{B} ( I , \tilde{I} , a , r )} \times log \frac{{P}_{D} ( I , \tilde{I} , a , r )}{{P}_{B} ( I , \tilde{I} , a , r )} \qquad ( 28 )$$

If the measure is considered as local, it could be modified as follows:

$${\frac{1}{{k}_{1} {k}_{2}} [ {\sum }_{i = 1}^{M} {\sum }_{j = 1}^{N} {( {I}_{ij} - {\tilde{I}}_{ij} )}^{2} ]}^{1 / 2} \times {\sum }_{l = 1}^{{k}_{2}} {\sum }_{k = 1}^{{k}_{1}} \frac{{{P}_{D} ( I , \tilde{I} , a , r )}_{; k , l}^{ω}}{{{P}_{B} ( I , \tilde{I} , a , r )}_{; k , l}^{ω}} log \frac{{{P}_{D} ( I , \tilde{I} , a , r )}_{; k , l}^{ω}}{{{P}_{B} ( I , \tilde{I} , a , r )}_{; k , l}^{ω}}$$

The algorithm for the color image brightness-darkness measure is:

### Color Image Brightness-Darkness Measure

### Algorithm

1—Taking an image

### 2—Transform RGB to CIE L*a*b

3—Consider “a” and “b” components and make two-dimension images: I(i, j) and Ĩ(i, j)
4—Apply two-dimensional histogram
5—Calculate brightness-darkness from the relation (28) and (29) as: P_{B}(I, Ĩ, a, r), P_{D}(I, Ĩ, a, r)
6—Evaluate Distance between I(i, j) and Ĩ(i, j) as: (I, Ĩ).
7—Multiply distance and brightness-darkness as the described measure

### Embodiment 8

### Multi-layer Brightness-Darkness Decomposition

In an embodiment, a new image decomposition system and method is described for color and gray level images. The decomposition is based on a brightness and darkness definition which is defined in embodiment 1 (relation 3). The decomposition is defined as:

$$I ( i , j ) = {\sum }_{k = 1}^{n} {I}_{B , k} ( i , j ) \pm {I}_{D , k} ( i , j )$$

Where I_{B,k} and I_{B,k} are the brightness and darkness components respectively. “n” stands for number of decomposition layers. The algorithm of the described image decomposition is defined as:

### Algorithm

1—Capturing an image
2—Select number of decomposition layers, “n”
3—Set k=1. k=1, . . . , n stands for the k^{th} layer of decomposition.
4—Determine the threshold based on the brightness-darkness separating system
5—Construct the brightness and darkness components
6—Assign k=k+1 and calculate the components for the next layer.

The brightness and darkness components are defines as:

$${I}_{B , k} ( i , j ) = \{ \begin{matrix}I ( i , j ) & I ( i , j ) > {T}_{k} \\ {T}_{k} & I ( i , j ) < {T}_{k}\end{matrix} \\ {I}_{D , k} ( i , j ) = I ( i , j ) - {I}_{B , k} ( i , j )$$

In general the brightness/Darkness components could be defined as:

I_{B,k}(i,j)=ƒ(I(i,j),Tₖ)

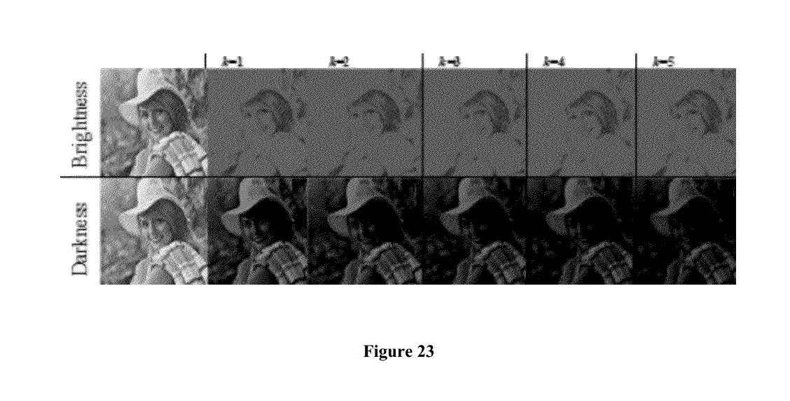

I_{D,k}(i,j)=I(i,j)−I_{B,k}(i,j)

Where the function, “ƒ”, could be linear/non-linear. The described decomposition could be used in image processing applications such as: image enhancement, segmentation, fusion and etc. The results of decomposition of a gray scale images are illustrated in FIG. 23.

### EXAMPLES

This section will provide some examples of the results of applying the described systems and methods for various data set and applications.

### Example 1

### Thermal-Image Enhancement Measure

In this section, the systems and methods are applied on a thermal-image dataset borrowed from (http://www.imaging1.com/gallery/index.html, March. 2013). The data set considered for computer simulation consists of an 11 set with 5 color thermal images and the rest are gray thermal images.

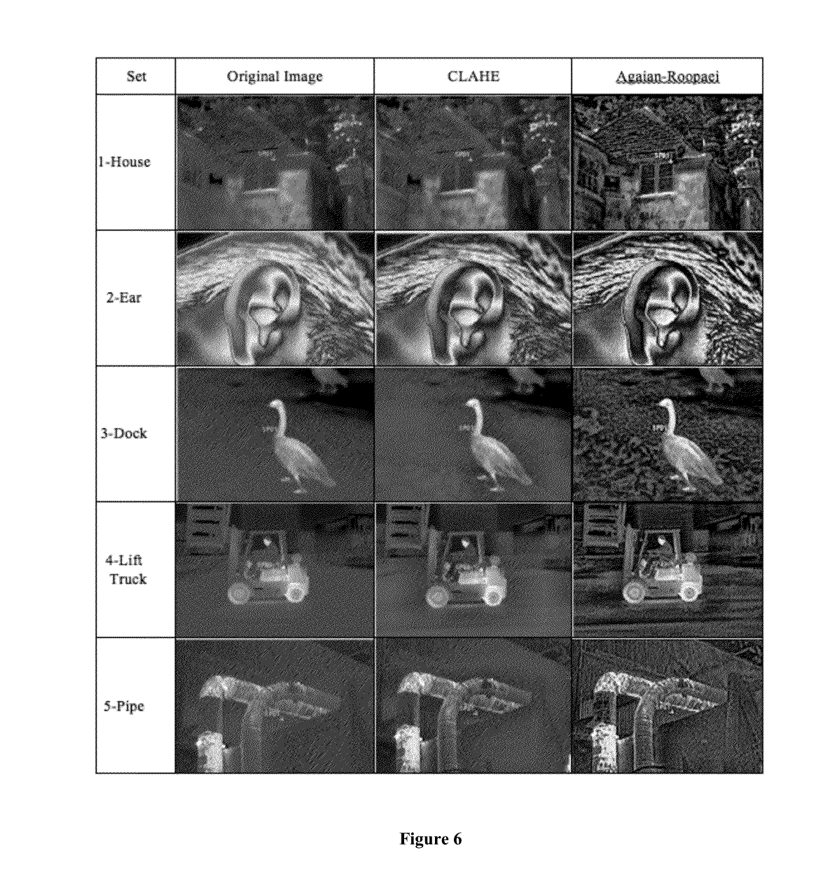

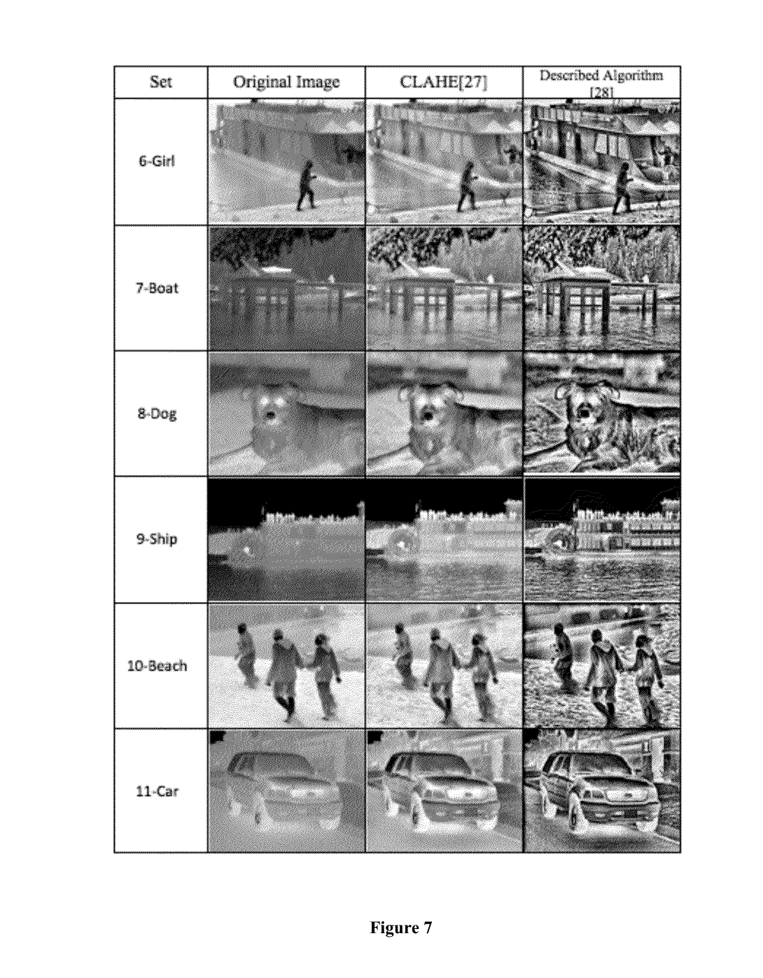

The results are considered in FIGS. 6 and 7. The results of applying the DMTE and DIMTE are demonstrated in Table 6 and Table 7.

TABLE 6
Results of applying DIMTE on dataset and compare with EME

| DIMTE V-channel | $\frac{1}{{k}_{1} {k}_{2}} {\sum }_{l = 1}^{{k}_{2}} {\sum }_{k = 1}^{{k}_{1}} ( \frac{{p}_{m ax ; k , l}}{{p}_{m i n ; k , l}} ) \times {( \frac{{I}_{m ax ; k , l}}{{I}_{m i n ; k , l}} )}^{2}$ | | | STD | EME | | | STD |
|---|---|---|---|---|---|---|---|---|
| Set 1-House | 1.07 | 1.11 | 2.11 | 0.58 | 0.47 | 0.41 | 0.67 | 0.13 |
| Set 2-Ear | 0.23 | 0.71 | 1.85 | 0.83 | 0.27 | 0.41 | 0.55 | 0.14 |
| Set 3-Dock | 0.44 | 0.47 | 0.74 | 0.16 | 0.22 | 0.23 | 0.34 | 0.06 |
| Set 4-Lift truck | 0.32 | 0.39 | 1.02 | 0.38 | 0.18 | 0.23 | 0.34 | 0.08 |
| Set 5-Pipe | 0.24 | 0.51 | 1.49 | 0.65 | 0.18 | 0.22 | 0.48 | 0.16 |
| Set 6-Girl | 1.18 | 1.2 | 2.21 | 0.59 | 0.48 | 0.52 | 0.73 | 0.13 |
| Set 7-Boat | 1.09 | 1.15 | 2.11 | 0.57 | 0.44 | 0.53 | 0.74 | 0.15 |
| Set 8-Dog | 0.24 | 0.74 | 1.77 | 0.78 | 0.22 | 0.37 | 0.59 | 0.18 |
| Set 9-Ship | 1.07 | 1.14 | 2.08 | 0.56 | 0.48 | 0.51 | 0.67 | 0.10 |
| Set 10-Beach | 1.72 | 1.87 | 2.20 | 0.25 | 0.61 | 0.64 | 0.83 | 0.11 |
| Set 11-Car | 0.33 | 1.14 | 1.59 | 0.63 | 0.22 | 0.39 | 0.53 | 0.15 |

TABLE 7
Results of applying DMTE on dataset and compare with EME

| DMTE V-channel | $\frac{1}{{k}_{1} {k}_{2}} {\sum }_{l = 1}^{{k}_{2}} {\sum }_{k = 1}^{{k}_{1}} log ( \frac{{\sum }_{m i n}^{t} {P}_{k , l}}{{\sum }_{t + 1}^{m ax} {P}_{k , l}} )$ | | | STD | EME | | | STD |
|---|---|---|---|---|---|---|---|---|
| Set 1-House | 0.40 | 0.51 | 0.79 | 0.20 | 0.47 | 0.41 | 0.67 | 0.13 |
| Set 2-Ear | 0.36 | 0.59 | 0.83 | 0.24 | 0.27 | 0.41 | 0.55 | 0.14 |
| Set 3-Dock | 0.09 | 0.2 | 0.54 | 0.23 | 0.22 | 0.23 | 0.34 | 0.06 |
| Set 4-Lift truck | 0.19 | 0.30 | 0.45 | 0.13 | 0.18 | 0.23 | 0.34 | 0.08 |
| Set 5-Pipe | 0.13 | 0.34 | 0.66 | 0.27 | 0.18 | 0.22 | 0.48 | 0.16 |
| Set 6-Girl | 0.53 | 0.73 | 0.92 | 0.19 | 0.48 | 0.52 | 0.73 | 0.13 |
| Set 7-Boat | 0.17 | 0.63 | 0.89 | 0.36 | 0.44 | 0.53 | 0.74 | 0.15 |
| Set 8-Dog | 0.14 | 0.65 | 0.84 | 0.36 | 0.22 | 0.37 | 0.59 | 0.18 |
| Set 9-Ship | 0.09 | 0.24 | 0.63 | 0.27 | 0.48 | 0.51 | 0.67 | 0.10 |
| Set 10-Beach | 0.5 | 0.65 | 0.84 | 0.17 | 0.61 | 0.64 | 0.83 | 0.11 |
| Set 11-Car | 0.15 | 0.56 | 0.7 | 0.28 | 0.22 | 0.39 | 0.53 | 0.15 |

### Example 2

### Engineering Application—Fault Detection-Maintenance

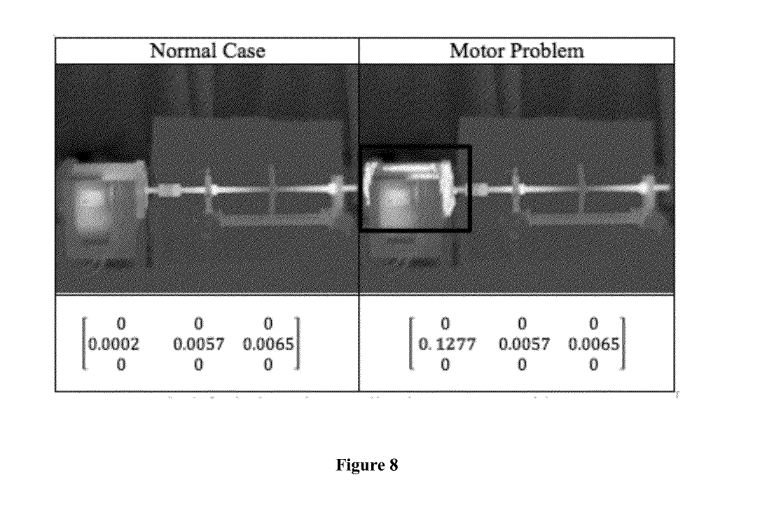

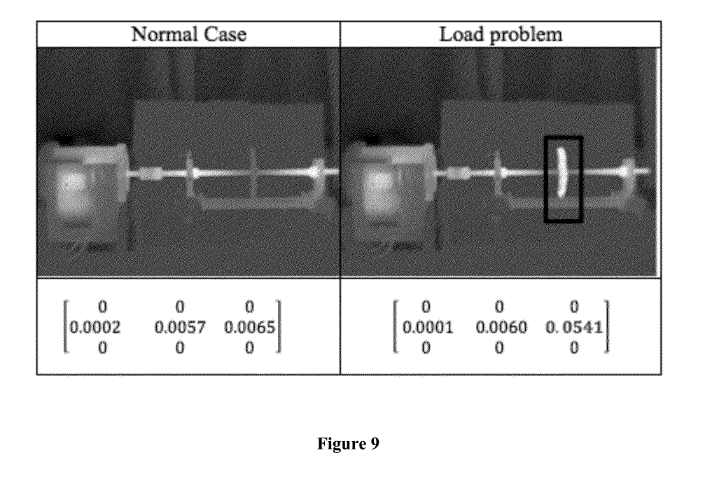

The system and methods could be applied as a fault detection and maintenance system. Consider the case that there is an issue occurring on a shaft of a DC motor so that it causes it to rotate with a higher velocity and accordingly the temperature of the joint will increase. By changing the temperature, the described system detects a difference for some block and then alerts the system that maybe something is wrong with the shaft. In the following thermal images for a motor, two different cases are illustrated. The results in FIGS. 8 and 9 show that the system detects some differences between the normal case and the case experiencing an anomaly for the motor and load problem.

### Example 3

### Control System: Transducer-Controller

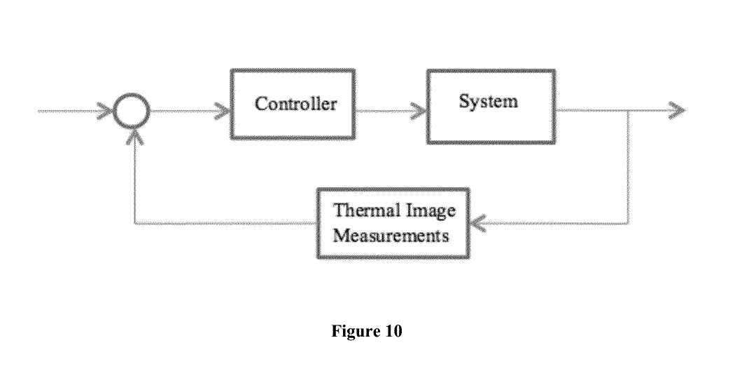

Transducer: The described system can be used as a transducer for a control system loop. The mentioned transducer is used not only for detecting the temperature but can also be used as a multi-purpose instrument for detecting, maintaining, and classifying fault (for the previous example, type of fault is different. One is motor fault and another is load problem) which is the main advantage of using the mentioned transducer rather than existing thermal transducers. In other words, it is more and goes above and beyond the usual temperature transducer. The applications of the innovated transducer is demonstrated in FIG. 10:

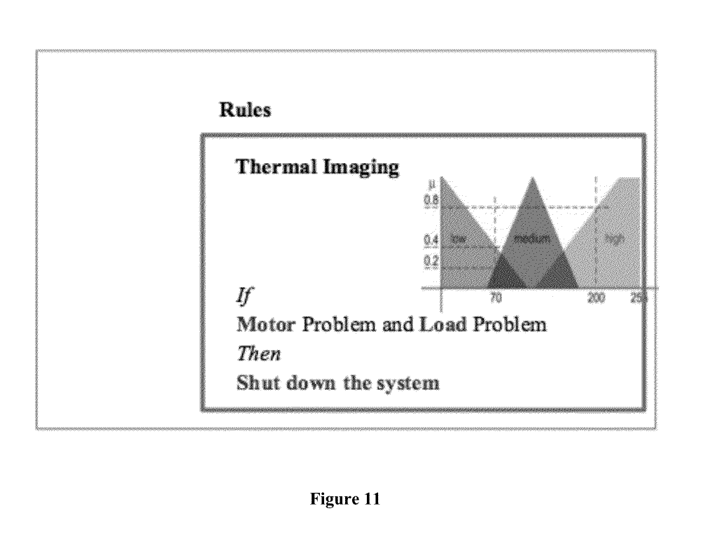

Controller: The described thermal image measurement can be also used as part of a controller. Rules of a fuzzy controller can be defined based on the information gathered from the thermal measurement system. In FIG. 11 is a sample expressed for the previous fault detection system.

### Example 4

### Medical Application—Medical Thermal Imaging

Medical Thermal Imaging or Thermography is a non-invasive clinical imaging technique for detecting and monitoring a number of diseases and physical injuries by showing any thermal abnormalities present in the body. Thermal imaging can detect many diseases and disorders in their early stages. Generally, a tumor is first detected by a mammogram when it is about 2.5 cm, or the size of a dime, and at this stage it has been growing for at least 8 years. Thermography can detect cancer 8-10 years earlier than a traditional mammogram when it is in its earlier stages.

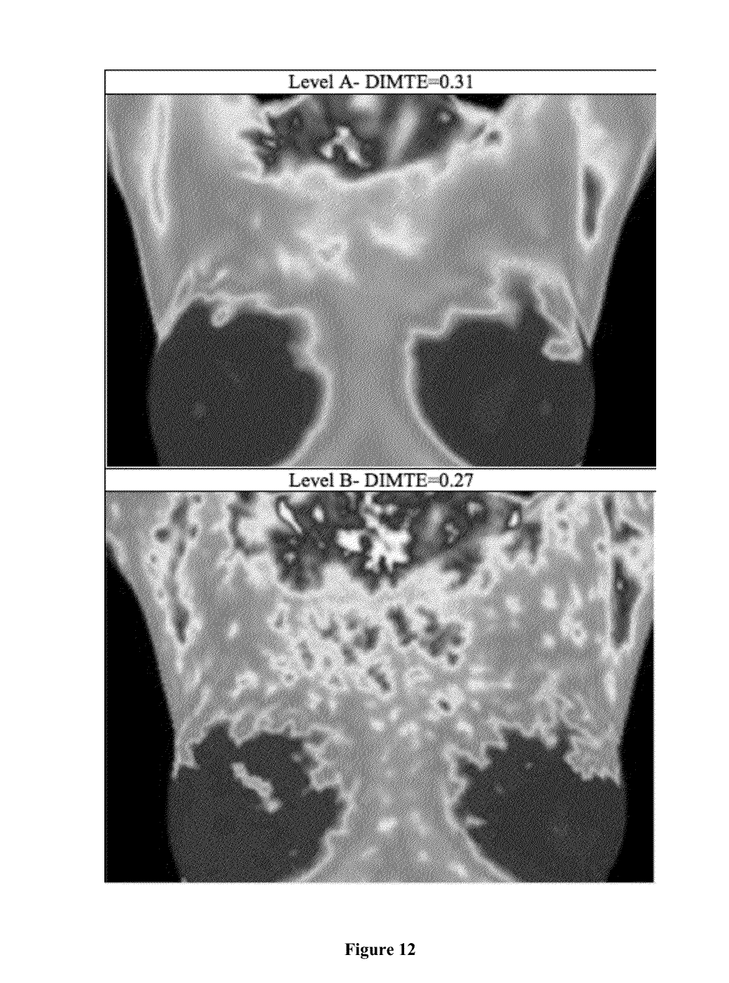

The introduced system and methods could be used to determine the cancer level or cancer progression. The results of applying the systems and methods for a case in detecting different levels of cancer are illustrated in FIG. 12.

### Example 5

### Communication Application—Measuring Cell Phone Radiation

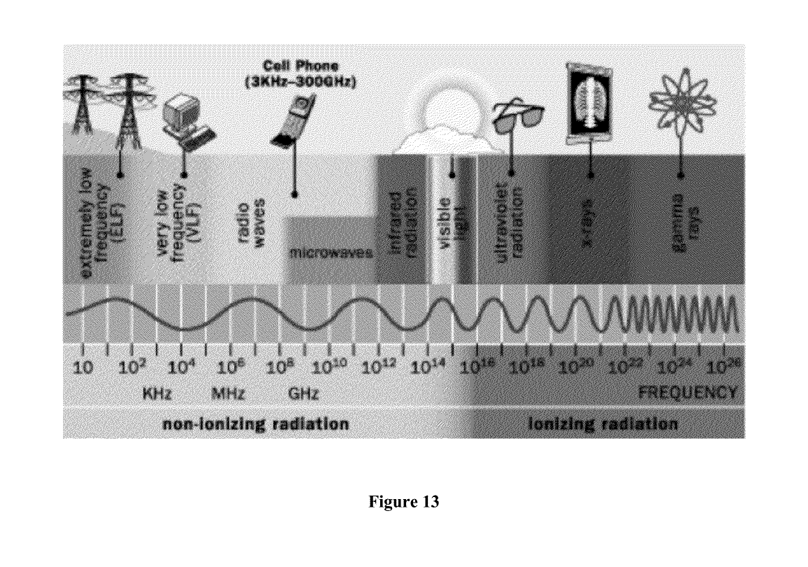

Electromagnetic radiation is made up of waves of electric and magnetic energy moving at the speed of light, according to the Federal Communications Commission (FCC). All electromagnetic energy falls somewhere on the electromagnetic spectrum, the ranges from extremely low frequency (ELF) radiation to X-rays and gamma rays as illustrated in FIG. 13 (http://www.lessrad4u.co.nz/education/electromagnetic-spectrum/). These levels of radiation affect biological tissue. When talking on a cell phone, most users place the phone against the head. In this position, there is a good chance that some of the radiation will be absorbed by human tissue. Some scientists believe that cell phones are harmful, and can find out what effects these ubiquitous devices may have.

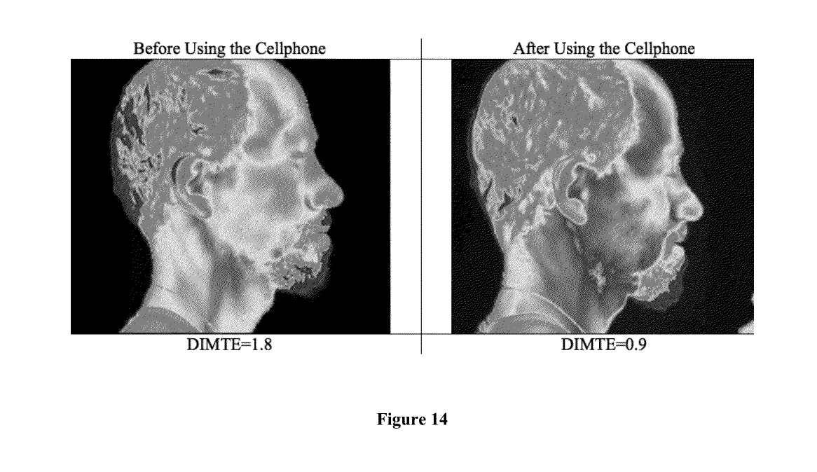

The introduced systems and methods could be applied for measuring cell phone radiation. The results of applying the systems and methods before and after using a cell phone are illustrated in FIG. 14.

### Example 6

### Image-Processing Application—Segmentation

In computer vision, image segmentation is the process of partitioning a digital image into multiple segments. The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain visual characteristics (http://en.wikipedia.org/wiki/Image_segmentation).

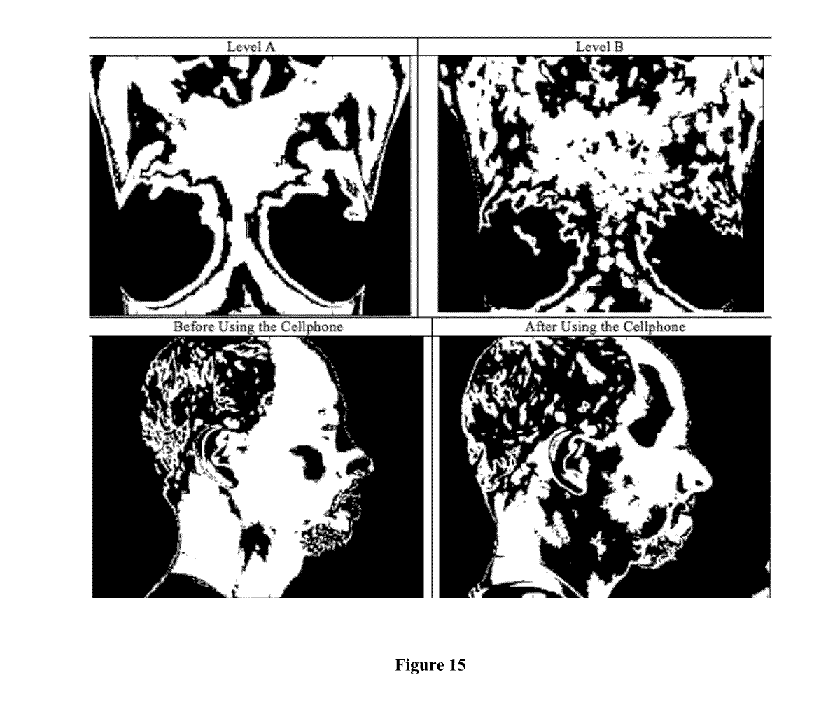

The introduced systems and methods could be utilized on image processing segmentation applications. The results of applying the segmentation for the cancer case and cell phone radiation mentioned in medical and communication application is illustrated as FIG. 15.

### Example 7

### Neurovascular Reactivity Measure

Thermal monitoring has been used in various medical applications like neurovascular reactivity measurement. To evaluate the neuro-vascular reactions in the skin of the hands of patients with the cervicobrachial syndrome was performed by distance infrared thermal imaging survey of the upper extremities and the measurement of dc electric bio potentials of the skin with electrodes, which are installed on the rear surface of the fingers of both hands, revealed enhancement of neuro-vascular reactions in the skin of fingers patients indicating cervicobrachial syndrome.

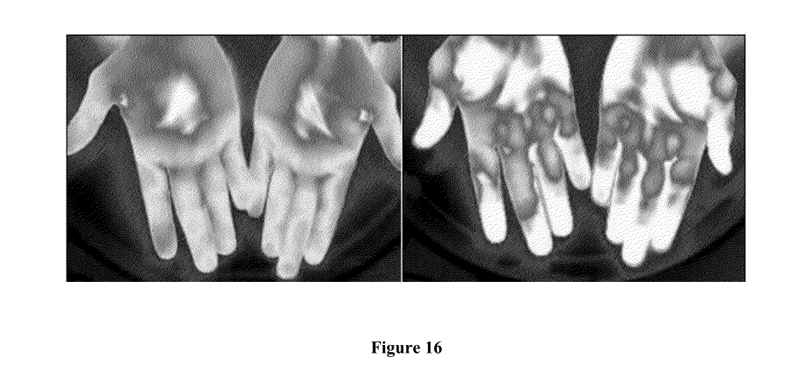

In (Naser Ahmadi, Vahid Nabavi, Vivek Nuguri, Fereshteh Hajsadeghi, Ferdinand Flores, Mohammad Akhtar, Stanley Kleis, Harvey Hecht, Morteza Naghavi, Matthew Budoff, “Low Fingertip Temperature Rebound Measured By Digital Thermal Monitoring Strongly Correlates With The Presence And Extent Of Coronary Artery Disease, CAD, Diagnosed By 64-Slice Multi-Detector Computed Tomography” Int J Cardiovasc Imaging (2009) 25:725-738, DOI 10.1007/s10554-009-9476-8,) study was designed to evaluate whether vascular dysfunction measured by thermal measuring correlates with the presence and extent of CAD diagnosed by computed tomography angiography in patients with suspected coronary artery disease FIG. 16.

According to the described measuring system and methods, measurements to determine a neurovascular reactivity of patient can be achieved.

### Example 8

### Image Enhancement

Image enhancement method expressed in embodiment 5 is evaluated for a special case where the nonlinear functions are: “log” and “sigmoid” for two layers as components. Several enhancement measures could be used as cost function. The cost function illustrated the performance of described methodology is MEMEE and the GA structure has the following characteristics:

TABLE 8
Genetic Algorithm Characteristic

| parameters | Illustration Value |
|---|---|
| Chromosome representation | Integer and floating point |
| population size | 20 |
| crossover probability | 0.75 |
| mutation probability | 0.025 |
| number of the generations | 60 |
| mutation value1 | 0.01 |
| mutation value2 | 1 |
| Fitness function | MEMEE |

Sigmoid function—The described method is very effective on thermal and infrared images. The results are compared with CLAHE and show that the current scheme has very better performance. For a particular case suppose the following relation:

Iₒᵤₜ=sigm(Iᵢₙ,40)−sigm(Iᵢₙ,70)+sigm(Iᵢₙ140)

2—Log function—consider n=2 in relation(**), the Iₒᵤₜ has the following relation:

$${I}_{out} = \frac{log ( 1 + \vert log ( 1 + μ \vert {I}_{in} - α \vert ) \vert )}{log ( 1 + \vert log ( 1 + \vert {I}_{in} - β \vert ) \vert )} \qquad ( 17 )$$

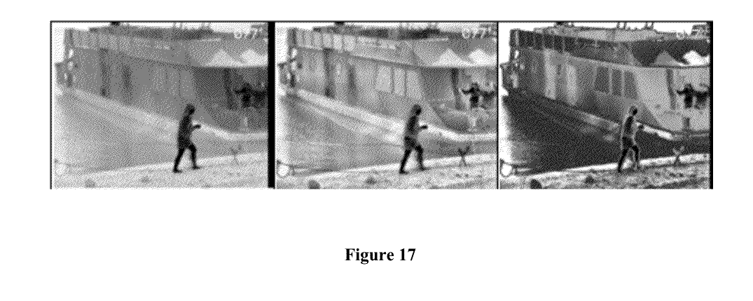

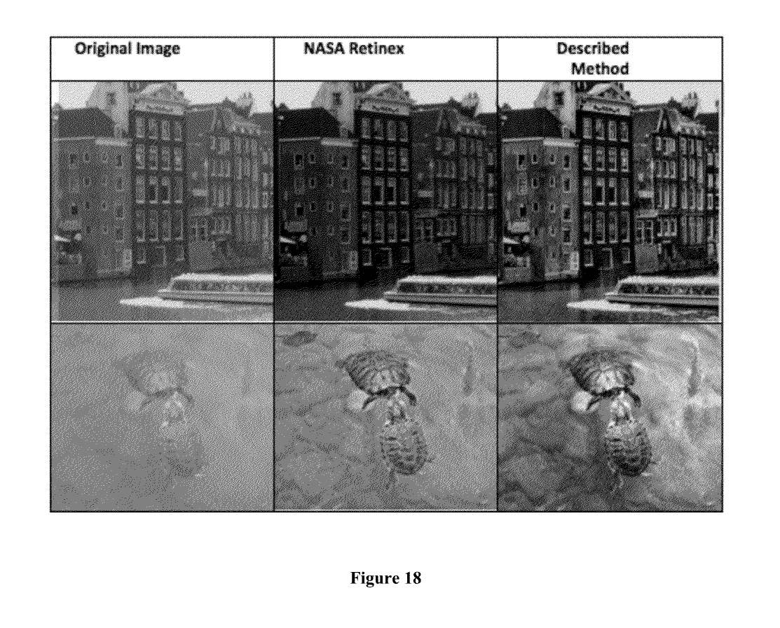

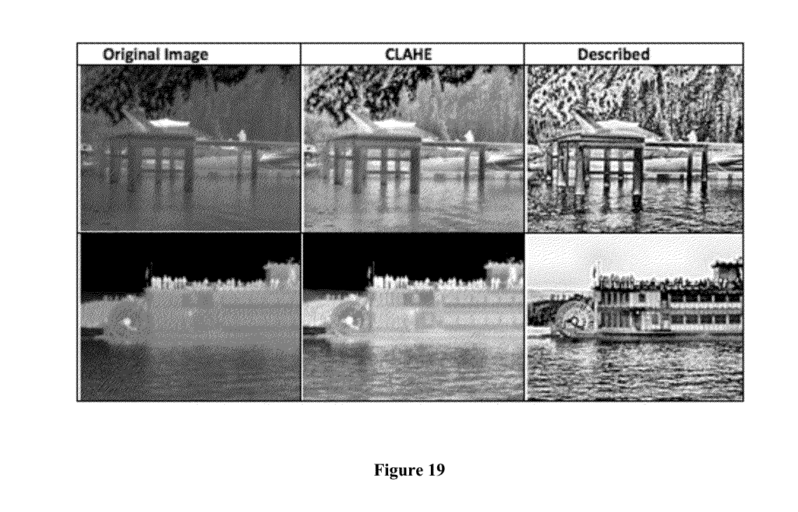

The results are demonstrated in FIGS. 17-19

### Example 9

### Cook-Bake Measurement System

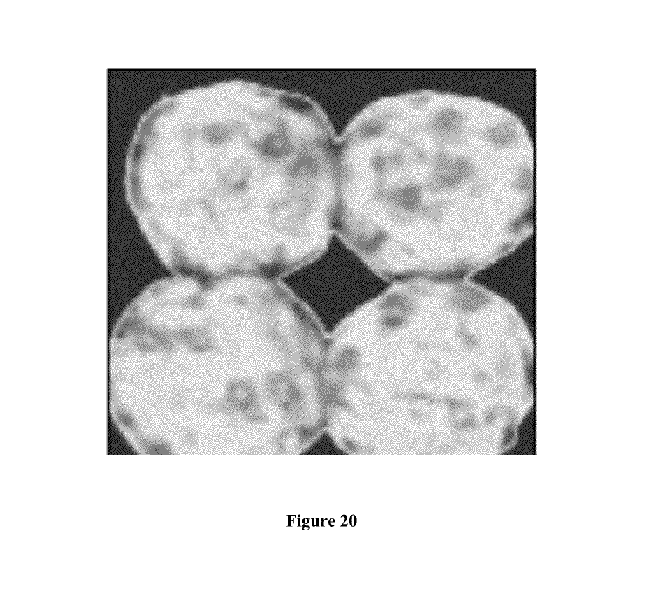

Food processing is a natural application for thermal imaging. Pre-cooked meats are an increasingly popular convenience for busy consumers. Cereals, pastries and snack foods all require precise baking protocols. In these food applications and many others, large volumes of food product must be cooked or baked with precision, FIG. 20.

According to the described measuring systems and methods, a measure to determine a cooking/baking level could be introduced.

### Example 10

### Earthquake Prediction Measure

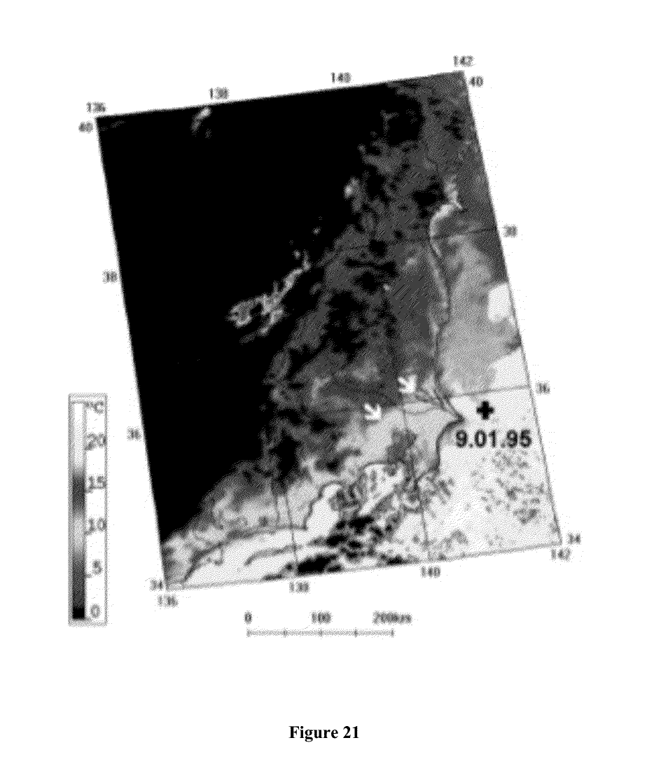

Thermal images indicate the presence of positive thermal anomalies that are associated with the large linear structures and fault systems of the Earth's crust. The relation between thermal anomalies and seismic activity was established for Middle Asia on the basis of a 7-year series of thermal images. (Andrew A. Tronina, Masashi Hayakawab, Oleg A. Molchanove, “Thermal IR Satellite Data Application For Earthquake Research in Japan and China”, Journal of Geodynamics, pp 519-534 2002), FIG. 21.

According to the described measuring system and methods, a measure to determine a level of prediction for earthquakes can be achieved.

### Example 11

### Web-Based Computer-Aided Detecting Energy Leaks in Buildings and Measure their Predictive Maintenance

Thermal imagers are a valuable tool in predictive maintenance of electrical, mechanical, and structural systems, to detect problems, prevent downtime, guide corrective action, and increase work safety. The cost of the cameras is very higher the cost of high-resolution far-infrared cameras is prohibitive for such widespread use—such cameras can cost $40,000 each Solutions: Develop 3D double camera scanning system by combining an inexpensive low-resolution thermal and commonly used cameras; developing a thermal imaging system for fast, reliable, accurate building diagnosis:

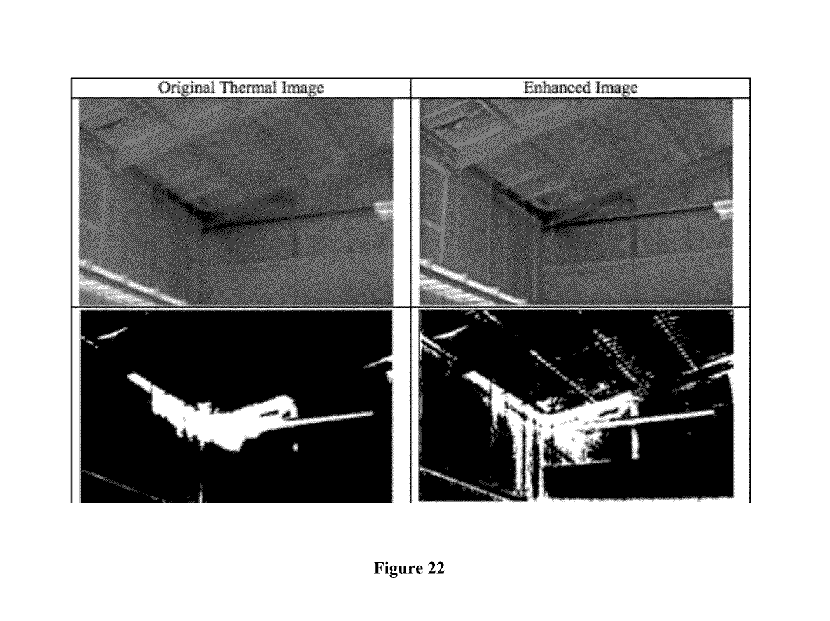

1. Including techniques to improve image quality (resolution, enhancement, de-noising)
2. Including database of materials and their cost
3. Including techniques to improve documentation of problems
4. Including defects classification tools
5. Web-based application (ASP.NET, Microsoft Corp.), handles Web forms for submission, assignment, and tracking requests
6. Including a database management system (SQL Server, Microsoft Corp) manages all information provided by the requestors and assigned analysts. The results are demonstrated in FIG. 22.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications of the disclosed system and method of use are directed to resource management of physical and data systems. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A thermal image and video processing system comprising:
a computing device configured to receive or store at least one thermal image and/or thermal video;
said computing device configured to apply steps to each said image or video, said steps comprising:
a first step of applying a color space transform to said image or video;
a next step of selecting a channel of said transformed image or video;
a next step of decomposing said image or video into blocks;
a next step of sorting the intensity and mass values within said blocks;
a next step of setting and achieving a threshold value for each said block;
a next step of separating the intensity of said block into a plurality of intervals;
and a last step of calculating the local block image quality components for each said image or video.

2. The system of claim 1, wherein said computing device is further configured to apply the step of providing image or video metrics based on the combination of all block metrics for said image or said video.

3. The system of claim 1, wherein said computing device is further configured to allow said steps to further comprise at least one linear metric function.

4. The system of claim 1, wherein said computing device is further configured to allow said steps to further comprise at least one non-linear metric functions.

5. The system of claim 1, wherein said computing device is further configured to allow said steps to further comprise at least one logarithmic model.

6. The system of claim 1, wherein said computing device is further configured to apply the step of providing image or video metrics based on the combination of all block metrics for said image or said video; and wherein said computing device is further configured to allow said steps to further comprise at least one linear and/or non-linear metric function; and wherein said computing device is further configured to allow said steps to further comprise at least one logarithmic model.

7. A method for processing thermal images and videos, comprising the steps of:
a first step of receiving or storing at least one thermal image and/or thermal video;
a next step of applying a color space transform to each said image or video;
a next step of selecting a channel of each said transformed image or video;
a next step of decomposing each said image or video into blocks;
a next step of sorting the intensity and mass values within said blocks;
a next step of setting and achieving a threshold value for each said image or video block;
a next step of separating the intensity of said block into a plurality of intervals;
and a last step of calculating the local block image quality components for each said image or video.

8. The method of claim 7, wherein an additional step is added of providing image or video metrics based on the combination of all block metrics for said image or said video.

9. The method of claim 7, wherein said steps are further comprised of at least one linear metric function.

10. The method of claim 7, wherein said steps are further comprised of at least one non-linear metric function.

11. The method of claim 7, wherein said steps are further comprised of at least one logarithmic model.

12. The method of claim 7, wherein an additional step is added of providing image or video metrics based on the combination of all block metrics for said image or said video; wherein said steps are further comprised of at least one linear and/or non-linear metric function; and wherein said steps are further comprised of at least one logarithmic model.

13. A thermal image and video processing system comprising:
a computing device configured to receive or store at least one thermal image and/or thermal video along with a corresponding reference thermal image and/or thermal video;
said computing device configured to apply steps to each said image or video, said steps comprising:
a first step of applying a color space transform to said image or video;
a next step of selecting a channel of said transformed image or video;
a next step of decomposing said image or video into blocks;
a next step of sorting the intensity and mass values within said blocks;
a next step of setting and achieving a threshold value for each said block;
a next step of separating the intensity of said block into a plurality of intervals;
and a last step of calculating the local block image quality components for said image.

14. The system of claim 13, wherein said computing device is further configured to apply the step of providing image or video metrics based on the combination of all block metrics for each said image or said video.

15. The system of claim 13, wherein said computing device is further configured to allow said steps to further comprise at least one linear metric function.

16. The system of claim 13, wherein said computing device is further configured to allow said steps to further comprise at least one non-linear metric functions.

17. The system of claim 13, wherein said computing device is further configured to allow said steps to further comprise at least one logarithmic model.

18. A method for processing thermal images and videos, comprising the steps of:
a first step of receiving or storing at least one thermal image and/or thermal video along with a corresponding reference thermal image and/or thermal video;
a next step of applying a color space transform to each said image or video;
a next step of selecting a channel of each said transformed image or video;
a next step of decomposing each said image or video into blocks;
a next step of sorting the intensity and mass values within each said image or video blocks;
a next step of setting and achieving a threshold value for each said block;
a next step of separating the intensity of said block into a plurality of intervals for each said image or video;
and a last step of calculating the local block image quality components for each said image or video.

19. The method of claim 18, wherein an additional step is added of providing image or video metrics based on the combination of all block metrics for each said image or said video.

20. The method of claim 18, wherein said steps are further comprised of at least one linear metric function.

21. The method of claim 18, wherein said steps are further comprised of at least one non-linear metric function.

22. The method of claim 18, wherein said steps are further comprised of at least one logarithmic model.

23. The method of claim 18, wherein an additional step is added of providing image or video metrics based on the combination of all block metrics for said image or said video; wherein said steps are further comprised of at least one linear and/or non-linear metric function; and wherein said steps are further comprised of at least one logarithmic model.
